(19) United States
(12) Patent Application Publication
(10) Pub. No.: US 2026/0121299 A1
(43) Pub. Date: Apr. 30, 2026

(54) ELECTRONIC DEVICE COMPRISING ANTENNA MODULE

(71) Applicant: LG ELECTRONICS INC., Seoul (KR)

(72) Inventors: Seungmin WOO, Seoul (KR); Yusuhk SUH, Seoul (KR); Dongik LEE, Seoul (KR)

(73) Assignee: LG ELECTRONICS INC., Seoul (KR)

(21) Appl. No.: 19/141,696

(22) PCT Filed: Dec. 22, 2022
(86) PCT No.: PCT/KR2022/021095

§ 371 Date: Jun. 20, 2025

(51) Int. Cl. H01Q 15/24; H01Q 1/22; H01Q 1/52; H01Q 9/04; H01Q 21/24

(52) U.S. Cl. CPC H01Q 15/24; H01Q 1/22; H01Q 1/526; H01Q 9/0414; H01Q 9/045; H01Q 21/24

(57) ABSTRACT

This antenna module comprises: a printed circuit board (PCB) implemented as a multilayer substrate formed by a plurality of dielectric layers; a feed pattern formed in a first layer of the multilayer substrate; a ground connection pattern formed in the first layer of the multilayer substrate; and a conductive pattern connected to the feed pattern and the ground connection pattern. The feed pattern includes a first sub pattern and a second sub pattern, and the ground connection pattern includes a third sub pattern and a fourth sub pattern. The distance between a first connection point between the first sub pattern and the second sub pattern and a second connection point between the third sub pattern and the fourth sub pattern may be formed to be different from the length of the conductive pattern.

### TECHNICAL FIELD

This specification relates to an antenna module and an electronic device including the same. A particular implementation relates to an antenna module implemented as a horizontally polarized antenna, and an electronic device including the antenna module.

### BACKGROUND ART

As functions of electronic devices diversify, an image display apparatus such as a multimedia player having composite functions such as playback of music or video files, games, broadcasting reception, etc. may be implemented.

The image display device is an apparatus that plays image content, and receives an image from various sources and plays the image back. The image display device is implemented as various devices such as a personal computer (PC), a smartphone, a tablet PC, a laptop computer, a TV, etc. The image display apparatus such as a smart TV, etc. may provide an application for providing web content such as a web browser, etc.

A communication module including an antenna may be provided so that the electronic device such as the image display device may perform communication with a peripheral electronic device. Meanwhile, recently, as a display arca of an image display device is enlarged, an arrangement space of a communication module including an antenna is reduced. Accordingly, there is an increasing need to arrange an antenna in a multilayer circuit substrate on which a communication module is implemented.

Meanwhile, a WiFi wireless interface may be taken into account, as an interface for a communication service between electronic devices. When such a WiFi wireless interface is used, a millimeter wave (mmWave) band may be used for high-speed data transmission between the electronic devices. In particular, high-speed data transmission between electronic devices may be performed using a wireless interface such as an 802.11ay wireless interface.

In relation to this, an array antenna capable of operating in a mmWave band may be mounted in an antenna module. However, electronic components such as an antenna and a transceiver circuit arranged in such an antenna module are configured to be electrically connected to each other. To do so, the transceiver circuit may be operably coupled to the antenna module, and the antenna module may be configured as a multilayer substrate.

As the multilayer substrate of the antenna module is arranged to have a planar stacked structure, a constraint may occur when a vertically polarized antenna is implemented. In this regard, a length of the vertically polarized antenna may be configured to be greater than a height of the multilayer substrate. Due to the constraint in the height of the multilayer substrate, there is a problem in that antenna performance may deteriorate when the vertically polarized antenna is configured to have a small length.

A horizontally polarized antennas may be designed to have a shape of a dipole antenna or a loop antenna. When a horizontally polarized antenna implemented as a dipole antenna is designed on a printed circuit board (PCB) together with a vertically polarized antenna, since overlap between structures is caused, actual implementation may not be performed easily. Even when a dual-polarized antenna is implemented to have an overlapping structure, feed lines between antennas need to be placed to be very close to each other. Accordingly, there is a problem in that great coupling occurs between antenna elements, thus significantly deteriorating antenna performance such as isolation characteristics. Therefore, there is such a problem that performance of isolation S21 cannot be improved due to coupling between antennas in an array structure of a horizontally polarized antenna having a dipole antenna structure.

### DISCLOSURE OF INVENTION

### Technical Problem

An object of this specification to solve the above-mentioned problems is to provide an antenna module in which a horizontally polarized antenna operating in a mmWave band is implemented, and an electronic device including the antenna module.

Another object of this specification is to propose a horizontally polarized antenna structure having a loop shape capable of sharing a space with a vertically polarized antenna.

Another object of this specification is to improve isolation characteristics between antenna elements having a loop shape.

Another object of this specification is to implement an end-fire antenna of a millimeter wave band, the end-fire antenna being configured to radiate from an end portion of one side of an antenna module implemented to have a multilayer substrate structure.

Another object of this specification is to maintain isolation characteristics between horizontally/vertically polarized antenna elements in a structure in which the horizontally polarized antenna having a loop shape and the vertically polarized antenna having a different structure share a space in a PCB.

Another object of this specification is to perform wireless communication with a peripheral electronic device by optimally arranging an antenna module on a lower portion of an electronic device.

Another object of this specification is to provide an antenna module in which a horizontally polarized antenna operating in a millimeter wave band is implemented, and an electronic device including the antenna module.

### Solution to Problem

To achieve these and other advantages and in accordance with the purpose of an embodiment, as embodied and broadly described herein, there is provided an antenna module including a multilayer substrate made of a plurality of dielectric materials and a conductive pattern. The multilayer substrate includes a first layer; and second layers and third layers arranged on one side surface and another side surface of the first layer, respectively. The conductive pattern may include: a first conductive pattern arranged on a first sub-layer which is one layer among the second layers; a second conductive pattern arranged to be spaced apart from the first conductive pattern on the first sub-layer; and a third conductive pattern configured to be connected to the first conductive pattern and the second conductive pattern. A distance between a first connection point between a first sub pattern and a second sub pattern of the first conductive pattern and a second connection point between a third sub pattern and a fourth sub pattern of the second conductive pattern may be configured to be different from a length of the third conductive pattern.

According to an embodiment, the multilayer substrate may include: a first layer made of a flexible first material; second layers including a plurality of layers made of a rigid second material arranged on one side surface of the first layer; and third layers including a plurality of layers made of the rigid second material arranged on another side surface of the first layer. The first layer may include a first region arranged in parallel with the second layers and the third layers and a second region arranged to be vertical to the second layers and the third layers. The first conductive pattern may include a first sub pattern and a second sub pattern, and the second conductive pattern may include a third sub pattern and a fourth sub pattern. The first sub pattern may be connected to a feed line of the multilayer substrate. The third sub pattern may be connected to a ground line of the multilayer substrate.

According to an embodiment, the first sub pattern may be arranged to be inclined toward an inner region with reference to the feed line. The second sub pattern may be arranged to be inclined toward an outer region with reference to the feed line. The third sub pattern may be arranged to be inclined toward an inner region with reference to the ground line. The fourth sub pattern may be arranged to be inclined toward an outer region with respect to the ground line.

According to an embodiment, a length of the third conductive pattern is configured to be greater than a space in a gap between the first connection point and the second connection point.

According to an embodiment, the first sub pattern may be arranged to be inclined toward an outer region with reference to the feed line, The second sub pattern may be arranged to be inclined toward an inner region with reference to the feed line. The third sub pattern may be arranged to be inclined toward an outer region with reference to the ground line. The fourth sub pattern may be arranged to be inclined toward an inner region with respect to the ground line.

According to an embodiment, a length of the third conductive pattern may be configured to be smaller than a space in a gap between the first connection point and the second connection point.

According to an embodiment, the conductive pattern may further include a fourth conductive pattern arranged on the one side surface in the first region and the second region of the one side surface of the first layer to transmit and receive a signal. The fourth conductive pattern arranged in the first region may be arranged in a middle region between the first conductive pattern and the second conductive pattern.

According to an embodiment, the multilayer substrate further may include a ground wall in which conductive patterns are connected between the plurality of dielectric layers through ground vias. The feed line connected to the first sub pattern may be arranged within the ground wall. The feed line may be arranged between ground patterns within the ground wall to constitute a coplanar waveguide (CPW) feed structure.

According to an embodiment, a distance d1, in a first axial direction, from one end portion of the first sub pattern to another end portion of the first sub pattern arranged at the first connection point may be configured as 0.06 λ₀<d1< a half of a length of the conductive pattern. A distance d2, in the first axial direction, from one end portion of the third sub pattern to another end portion of the second sub pattern arranged at the second connection point may be configured as 0.06 λ₀<d2< a half of a length of the conductive pattern.

According to an embodiment, a length of the first sub pattern may be configured to be greater than a length of the third sub pattern. A first point on a second axis of the feed line connected to one end portion of the first sub pattern may be a further inner point in the printed circuit board (PCB) compared to a second point on the second axis of the ground line connected to one end portion of the third sub pattern.

According to an embodiment, the first connection point between the first sub pattern and the second sub pattern and the second connection point between the third sub pattern and the fourth sub pattern may be arranged at a same point in a second axial direction vertical to the first axial direction.

According to an embodiment, an electrical length of the antenna element including the first conductive pattern, the second conductive pattern, and the third conductive pattern may be set to a predetermined range with reference to one time an operating wavelength (Ag) corresponding to an operating frequency.

According to an embodiment, the antenna element may operate as a horizontally polarized antenna. The antenna module may further include a vertically polarized antenna including the fourth conductive pattern vertically connected to a feed pattern arranged on a second sub-layer other than the first sub-layer to extend to an upper region. The vertically polarized antenna may include a fifth conductive pattern arranged on a third sub-layer, which is one layer among the third layers, and a sixth conductive pattern arranged on a fourth sub-layer, which is another layer among the third layers. The fifth conductive pattern and the sixth conductive pattern may be connected to each other through a via structure. The via structure may include via holes arranged in a plurality of rows and stacked vertically.

According to an embodiment, the antenna element may be arranged in plurality in the first axial direction to constitute an array antenna. A first horizontally polarized antenna element to a fourth horizontally polarized antenna element of the array antenna may be configured to radiate a beamformed first wireless signal in the first axial direction. A first vertically polarized antenna element to a fourth vertically polarized antenna element of the array antenna may be configured to radiate a beamformed second wireless signal in the first axial direction.

According to an embodiment, sub patterns constituting ground connection patterns of the first horizontally polarized antenna may be connected to each other at a second point in the second axial direction. Sub patterns constituting a feed pattern of the second horizontally polarized antenna adjacent to the first horizontally polarized antenna may be connected to each other at a third point in the second axial direction. The third point may be configured as a point different from the second point in the second axial direction so that shapes of the first horizontally polarized antenna and the second horizontally polarized antenna are different from each other.

According to an embodiment, the third point may be arranged in a further inner region in the PCB compared to the second point. A distance d3 from the second point to the third point is configured to be 0.04 λ₀ or greater.

According to an embodiment, the antenna module may further include a shield can arranged on a ground pattern in an upper portion of the ground wall of the printed circuit board (PCB). A distance d from the shield can to the third conductive pattern arranged on a flexible printed circuit board (FPCB) may be configured to be in a range of (0.17+n)*λ₀<(0.33+n)*λ₀.

An electronic device according to another aspect of this specification may include a metal frame constituting a side surface region of the electronic device; a dielectric case arranged on one side of the metal frame; and an antenna module arranged in an inner region of the dielectric case, arranged to face an inner surface of the dielectric case, and including a multilayer substrate made of a plurality of dielectric materials and a conductive pattern. The multilayer substrate includes a first layer; and second layers and third layers arranged on one side surface and another side surface of the first layer, respectively. The conductive pattern may include: a first conductive pattern arranged on a first sub-layer which is one layer among the second layers; a second conductive pattern arranged to be spaced apart from the first conductive pattern on the first sub-layer; and a third conductive pattern configured to be connected to the first conductive pattern and the second conductive pattern. A distance between a first connection point between a first sub pattern and a second sub pattern of the first conductive pattern and a second connection point between a third sub pattern and a fourth sub pattern of the second conductive pattern may be configured to be different from a length of the third conductive pattern.

According to an embodiment, the multilayer substrate may include: a first layer made of a flexible first material; second layers including a plurality of layers made of a rigid second material arranged on one side surface of the first layer; and third layers including a plurality of layers made of the rigid second material arranged on another side surface of the first layer. The first layer may include a first region arranged in parallel with the second layers and the third layers and a second region arranged to be vertical to the second layers and the third layers. The first conductive pattern may include a first sub pattern and a second sub pattern, and the second conductive pattern may include a third sub pattern and a fourth sub pattern. The first sub pattern may be connected to a feed line of the multilayer substrate. The third sub pattern may be connected to a ground line of the multilayer substrate.

According to an embodiment, the first sub pattern may be arranged to be inclined toward an inner region with reference to the feed line. The second sub pattern may be arranged to be inclined toward an outer region with reference to the feed line. The third sub pattern may be arranged to be inclined toward an inner region with reference to the ground line. The fourth sub pattern may be arranged to be inclined toward an outer region with respect to the ground line.

According to an embodiment, a length of the third conductive pattern may be configured to be greater than a space in a gap between the first connection point and the second connection point.

According to an embodiment, the first sub pattern may be arranged to be inclined toward an outer region with reference to the feed line. The second sub pattern may be arranged to be inclined toward an inner region with reference to the feed line. The third sub pattern may be arranged to be inclined toward an outer region with reference to the ground line. The fourth sub pattern may be arranged to be inclined toward an inner region with respect to the ground line.

According to an embodiment, a length of the third conductive pattern is configured to be smaller than a space in a gap between the first connection point and the second connection point.

### Advantageous Effects of Invention

Hereinafter, technical effects of an antenna module implemented as a horizontally polarized antenna according to this specification and an electronic device including the antenna module are described.

According to an embodiment, an antenna module in which a horizontally polarized antenna operating in a millimeter wave band is implemented, and an electronic device including the antenna module may be provided.

According to an embodiment, isolation characteristics between horizontally polarized antenna elements having a loop shape in which a feed pattern and a ground conductive pattern are configured to have an inwardly concave structure may be improved.

According to an embodiment, isolation characteristics between horizontally polarized antenna elements having a loop shape in which a feed pattern and a ground conductive pattern are configured to have an outwardly convex structure may be improved.

According to an embodiment, horizontally polarized antenna elements having a loop shape may share a space with vertically polarized antennas while avoiding overlapping therebetween.

According to an embodiment, isolation characteristics between antenna elements may be improved through a sigma-loop shape having an orthogonal arrangement structure between corresponding sub patterns between adjacent antenna elements.

According to an embodiment, an end-fire antenna of a millimeter wave band, the end-fire antenna being configured to radiate from an end portion of one side of an antenna module implemented to have a multilayer substrate structure, may be implemented.

According to an embodiment, isolation characteristics between horizontally/vertically polarized antenna elements may be maintained in a structure in which the horizontally polarized antenna having a loop shape and the vertically polarized antenna having a different structure share a space in a PCB.

According to an embodiment, wireless communication may be performed with a peripheral electronic device by optimally arranging an antenna module on a lower portion of an electronic device.

Further scope of applicability of this specification will become apparent from the following detailed description. It should be understood, however, that the detailed description and specific examples, such as the preferred embodiment of the disclosure, are given by way of illustration only, since various changes and modifications within the spirit and scope of the disclosure will be apparent to those skilled in the art.

### BRIEF DESCRIPTION OF DRAWINGS

FIG. 1 is a diagram schematically illustrating an example of a whole wireless audio-video (AV) system including an image display device according to one embodiment of this specification.

FIG. 2 illustrates a detailed configuration of electronic devices that support a wireless interface according to this specification.

FIG. 3A illustrates a request-to-send frame (RTS) and a clear-to-send (CTS) frame according to this specification.

FIG. 3B illustrates a block diagram of a communication system 400 according to an example of this specification.

FIG. 4 illustrates an electronic device in which a plurality of antenna modules and a plurality of transceiver circuit modules are arranged, according to an embodiment.

FIG. 5A illustrates a configuration in which a multilayer circuit substrate on which an array antenna module is arranged is connected to a radio frequency integrated chip (RFIC), in relation to this specification.

FIG. 5B is a conceptual diagram illustrating antenna structures having different radiation directions.

FIG. 5C illustrates a combination structure between a multilayer substrate and a main substrate according to embodiments.

FIG. 6 is a conceptual diagram illustrating a plurality of communication modules arranged in a lower portion of an image display device, a configuration of the corresponding communication modules, and communication performed between the communication modules and other communication modules arranged in a front direction.

FIG. 7A is a perspective view of a structure in which a printed circuit board (PCB) and a flexible printed circuit board (FPCB) each having antenna elements arranged thereon are connected to each other.

FIG. 7B illustrates a structure of a horizontally polarized antenna exposed due to removal of a dielectric region of the PCB of FIG. 7A.

FIG. 8 illustrates sigma-loop antennas configured to have concave and convex structures according to embodiments.

FIG. 9 illustrates structures in which feed patterns and/or ground connection patterns according to embodiments are connected to each other by a via structure.

FIG. 10A illustrates an array antenna constituted by antenna elements having a sigma-loop structure according to this specification and a shape of each antenna element.

FIG. 10B shows a comparison between isolation characteristics between antenna elements according to different loop structures in the array antenna of FIG. 10A.

FIG. 11A illustrates a current distribution of an antenna having a loop shape of a first structure.

FIG. 11B illustrates a current distribution of an antenna having a sigma-loop shape of a second structure.

FIG. 12A illustrates a structure in which a sigma-loop antenna according to this specification is configured to be concave inwardly.

FIG. 12B shows a comparison between isolation characteristics according to a distance at which a feed pattern and a ground connection pattern are arranged inwardly in the sigma-loop antenna of FIG. 12A.

FIG. 13A illustrates a structure in which points at which sigma-loop antenna elements are configured to be concave are misaligned in a second axial direction.

FIG. 13B shows isolation characteristics according to a distance in correspondence with the misalignment of FIG. 13A.

FIG. 14A is a side view of a dual-polarized antenna structure in which a PCB is connected to an FPCB.

FIG. 14B illustrates a structure of the dual-polarized antenna exposed due to removal of a dielectric region of the PCB of FIG. 14A.

FIG. 15A illustrates an antenna module in which a horizontally polarized antenna implemented as a sigma-loop antenna and a vertically polarized antenna are implemented as a dual polarized array antenna.

FIG. 15B illustrates a structure in which a shield can is arranged on an upper portion of a PCB of the antenna module of FIG. 15A.

FIG. 16A illustrates a front view of an array antenna module in which the shield can of FIG. 15B is arranged and an enlarged view of a sigma-loop antenna.

FIG. 16B is a side view of the array antenna module in which the shield can of FIG. 16A is arranged.

FIG. 16C shows gain characteristics of a horizontally polarized antenna according to a distance from an end portion of the shield can of FIGS. 16A and 16B to a vertically polarized antenna in the array antenna structure in which the shield can is arranged.

FIG. 17 illustrates an electronic device having an antenna module arranged in a dielectric case according to this specification.

FIG. 18A illustrates a structure in which an antenna module constituted by a plurality of array antennas is arranged in an electronic device.

FIG. 18B is an enlarged view of a plurality of array antenna modules of FIG. 18A.

FIG. 19 illustrates antenna modules combined to have different combination structures in a particular position in the electronic device according to embodiments.

### MODE FOR THE INVENTION

A description will now be given in detail according to embodiments disclosed herein, with reference to the accompanying drawings. For the sake of a brief description with reference to the drawings, the same or equivalent components may be provided with the same reference numbers, and the description thereof will not be repeated. Suffixes “module” and “unit” used for components used in the following description are merely intended for easy description of this specification, and each suffix itself is not intended to give any special meaning or function. In describing the embodiments disclosed herein, moreover, the detailed description will be omitted when specific description for publicly known technologies to which the disclosure pertains is judged to obscure the gist of this specification. The accompanying drawings are used to help easily understand the technical idea of this specification and it should be understood that the idea of this specification is not limited by the accompanying drawings. The idea of this specification should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected” or “coupled” to another element, the element may be directly connected or coupled to the another element, or intervening elements may also be present. In contrast, when an element is referred to as being “directly connected with”another element, there are no intervening elements present.

A singular representation may include a plural representation unless it represents a definitely different meaning from the context.

Terms such as “include” or “has” as used herein should be understood that they are intended to indicate the existence of a feature, a number, a step, an element, a component, or a combination thereof disclosed in this specification, and it may also be understood that a possibility of presence or addition of one or more other features, numbers, steps, elements, components, or combinations thereof are not excluded in advance,

An electronic device described herein may include a mobile phone, a smartphone, a laptop computer, a digital broadcasting terminal, a personal digital assistant (PDA), a portable multimedia player (PMP), a navigation system, a slate personal computer (PC), a tablet PC, an ultrabook, a wearable device, (e.g., a smartwatch, smart glasses, a head mounted display (HMD)), or the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, digital signage, and the like.

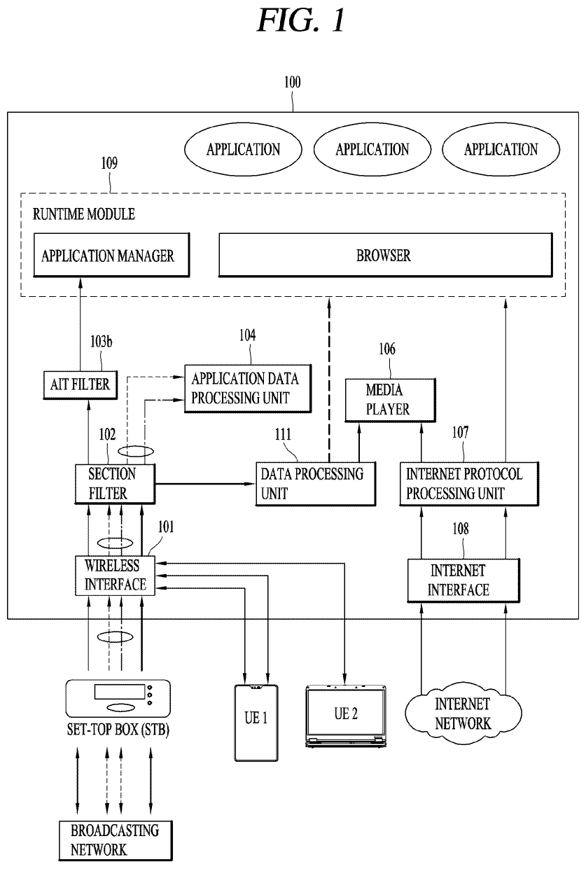

FIG. 1 is a diagram schematically illustrating an example of a whole wireless audio-video (AV) system including an image display device according to one embodiment of this specification.

As illustrated in FIG. 1, an image display device 100 according to another embodiment of the present disclosure is connected to the wireless AV system (or a broadcasting network) and an Internet network. The image display device 100 may be, for example, a network TV, a smart TV, a hybrid broadcast broadband TV (HBBTV), or the like.

The image display device 100 may be wirelessly connected to the wireless AV system (or the broadcasting network) via a wireless interface or wirelessly or wiredly connected to the Internet network via an Internet interface. In relation to this, the image display device 100 may be configured to be connected to a server or another electronic device via a wireless communication system. As an example, the image display device 100 needs to provide an 802.111ay communication service operating in a millimeter wave (mmWave) band to transmit or receive large-capacity data at a high speed.

The mm Wave band may be any frequency band in a range of 10 GHz to 300 GHz. In this disclosure, the mm Wave band may include an 802.11ay band of a 60 GHz band. In addition, the mm Wave band may include a 5G frequency band of a 28 GHz band or the 802.11ay band of the 60 GHz band. The 5G frequency band may be set to about 24 to 43 GHz band and the 802.11ay band may be set to 57 to 70 GHz or 57 to 63 GHz band, but are not limited thereto.

Meanwhile, the image display device 100 may wirelessly transmit or receive data to/from an electronic device in a periphery of the image display device 100, e.g., a set-top box or another electronic device via the wireless interface. As an example, the image display device 100 may transmit or receive wireless AV data to/from a set-top box or another electronic device, e.g., a mobile terminal arranged in front of or below the image display device.

The image display device 100 includes, for example, a wireless interface 101b, a section filter 102b, an application information table (AIT) filter 103b, an application data processing unit 104b, a data processing unit 111b, a media player 106b, an Internet protocol processing unit 107b, an Internet interface 108b, and a runtime module 109b.

Through the broadcast interface 101b, application information table (AIT) data, real-time broadcast content, application data, and a stream event are received. Meanwhile, the real-time broadcast content may be referred to as linear audio/video (A/V) content.

The section filter 102b performs section filtering on four types of data received through the wireless interface 101b to transmit the AIT data to the AIT filter 103b, the linear A/V content to the data processing unit 111b, and the stream events and the application data to the application data processing unit 104b.

Meanwhile, the non-linear A/V content and the application data are received through the Internet interface 108b. The non-linear A/V content may be, for example, a content on demand (COD) application. The non-linear A/V content is transmitted to the media player 106b, and the application data is transmitted to the runtime module 109b.

Further, the runtime module 109b includes, for example, an application manager and a browser as illustrated in FIG. 1. The application manager controls a life cycle of an interactive application using, for example, the AIT data. In addition, the browser performs, for example, a function of displaying and processing the interactive application.

Hereinafter, a communication module having an antenna for providing a wireless interface in an electronic device such as the above-described image display device is described in detail. In relation to this, the wireless interface for communication between electronic devices may be a WiFi wireless interface, but is not limited thereto. As an example, a wireless interface supporting an 802.11ay standard may be provided for high-speed data transmission between electronic devices.

The 802.11ay standard is a subsequent standard for increasing a throughput of an 802.11ad standard to 20 Gbps or greater. An electronic device supporting the 802.11ay wireless interface may be configured to use a frequency band of about 57 to 64 GHz. The 802.11ay wireless interface may be configured to provide backward compatibility for an 802.11ad wireless interface. Meanwhile, the electronic device providing the 802.11ay wireless interface may be configured to provide coexistence with a legacy device using the same band.

In relation to a wireless environment for the 802.11ay standard, a configuration may be such that a coverage of 10 meters or longer is provided in an indoor environment, and a coverage of 100 meters or longer is provided in an outdoor environment with a line of sight (LOS) channel condition.

The electronic device supporting the 802.11ay wireless interface may be configured to provide visual reality (VR) headset connectivity, support server backups, and support cloud applications that need low latency.

An ultra short range (USR) communication scenario, i.e., a near field communication scenario which is a use case of the 802.11ay wireless interface is a model for fast large-capacity data exchange between two terminals. The USR communication scenario may be configured to require low power consumption of less than 400 mW, while providing a fast link setup within 100 msec, transaction time within 1 second, and a 10 Gbps data rate at a very close distance of less than 10 cm.

As the use case of the 802.11ay wireless interface, an 8K UHD wireless transfer at smart home usage model may be taken into account. In the smart home usage model, a wireless interface between a source device and a sync device may be taken into consideration to stream 8K UHD content at home. In relation to this, the source device may be one of a set-top box, a Blue-ray player, a tablet PC, and a smart phone and the sink device may be one of a smart TV and a display device, but are not limited thereto. In relation to this, the wireless interface may be configured to transmit uncompressed 8K UHD streaming data (60 fps, 24 bits per pixel, at least 4:2:2) with a coverage of less than 5 m between the source device and the sink device. To do so, the wireless interface may be configured such that data is transmitted between electronic devices at a speed of at least 28 Gbps.

In order to provide such a wireless interface, embodiments related to an array antenna operating in a mm Wave band and an electronic device including the array antenna is described with reference to the accompanying drawings. It will be apparent to those skilled in the art that this specification may be embodied in other specific forms without departing from the spirit or essential characteristics thereof.

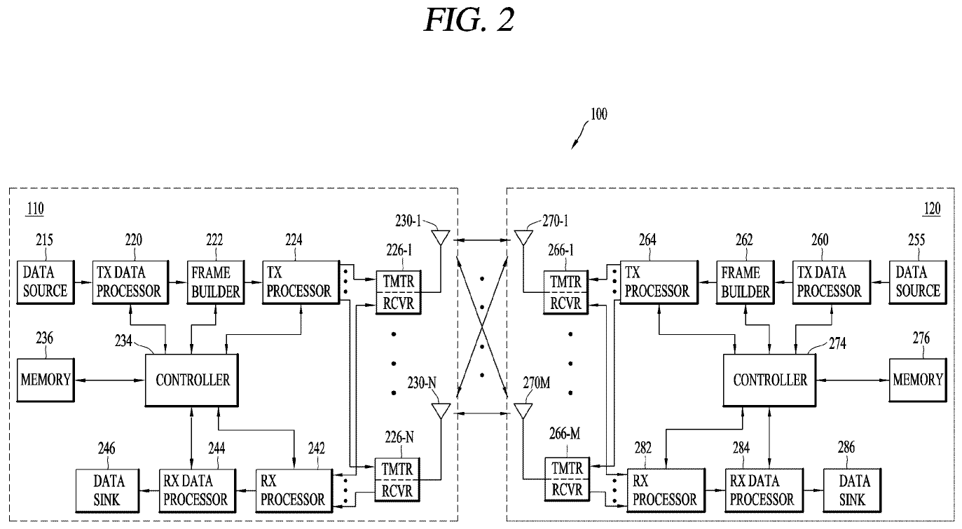

FIG. 2 illustrates a detailed configuration of electronic devices that support a wireless interface according to this specification. FIG. 2 illustrates a block diagram of an access point 110 (generally, a first wireless node) and an access terminal 120 (generally, a second wireless node) in a wireless communication system. The access point 110 is a transmitting entity for downlink transmission and a receiving entity for uplink transmission. The access terminal 120 is a transmitting entity for uplink transmission and a receiving entity for downlink transmission. As used herein, the “transmitting entity” is an independently operating apparatus or device capable of transmitting data through a wireless channel, and the “receiving entity” is an independently operating apparatus or device capable of receiving data through a wireless channel.

Referring to FIGS. 1 and 2, a set-top box STB of FIG. 1 may be the access point 110, and an electronic device 100 of FIG. 1 may be the access terminal 120, but are not limited thereto. Accordingly, it should be understood that the access point 110 may alternatively be an access terminal, and the access terminal 120 may alternatively be an access point.

To transmit data, the access point 110 includes a transmission data processor 220, a frame builder 222, a transmission processor 224, a plurality of transceivers 226-1 to 226-N, and a plurality of antennas 230-1 to 230-N. The access point 110 also includes a controller 234 configured to control operations of the access point 110.

To transmit data, the access point 110 includes the transmission data processor 220, the frame builder 222, the transmission processor 224, the plurality of transceivers 226-1 to 226-N, and the plurality of antennas 230-1 to 230-N. The access point 110 also includes the controller 234 configured to control operations of the access point 110.

During operation, the transmission data processor 220 receives data (e.g., data bits) from a data source 215, and processes the data for transmission. For example, the transmission data processor 220 may encode data (e.g., data bits) into encoded data, and modulate the encoded data into data symbols. The transmission data processor 220 may support different modulation and coding schemes (MCSs). For example, the transmission data processor 220 may the encode data at any one of a plurality of different coding rates (e.g., using low-density parity check (LDPC) encoding). In addition, the transmission data processor 220 may modulate the encoded data using any one of a plurality of different modulation schemes including, but not limited to, BPSK, QPSK, 16QAM, 64QAM, 64APSK, 128APSK, 256QAM, and 256APSK.

The controller 234 may transmit, to the transmission data processor 220, a command for specifying an MCS to be used (e.g., based on channel conditions for downlink transmission). The transmission data processor 220 may encode and modulate the data received from the data source 215 according to the specified MCS. It needs to be recognized that the transmission data processor 220 may perform additional processing on the data, such as data scrambling and/or other processing. The transmission data processor 220 outputs the data symbols to the frame builder 222.

The frame builder 222 builds a frame (also referred to as a packet) and inserts the data symbols into a data payload of the frame. The frame may include a preamble, a header, and a data payload The preamble may include a short training field (STF) sequence and a channel estimation (CE) sequence to assist the access terminal 120 in receiving the frame. The header may include information regarding data in a payload, such as a length of the data and an MCS used to encode and modulate the data. Based on this information, the access terminal 120 may demodulate and decode the data. The data in the payload may be partitioned among a plurality of blocks, and each block may contain a part of the data and a guard interval (GI) to assist the receiver in phase tracking. The frame builder 222 outputs the frame to the transmission processor 224.

The transmission processor 224 processes the frame for transmission on downlink. For example, the transmission processor 224 may support different transmission modes, e.g., an orthogonal frequency-division multiplexing (OFDM) transmission mode and a single-carrier (SC) transmission mode. In this example, the controller 234 may transmit, to the transmission processor 224, a command for specifying a transmission mode to be used, and the transmission processor 224 may process the frame for transmission according to the specified transmission mode. The transmission processor 224 may apply a spectrum mask to the frame so that a frequency configuration of a downlink signal complies with particular spectrum requirements.

The transmission processor 224 may support multiple-input-multiple-output (MIMO) transmission. In these aspects, the access point 110 may include a plurality of antennas 230-1 to 230-N and a plurality of transceivers 226-1 to 226-N (e.g., one for each antenna), The transmission processor 224 may perform spatial processing on incoming frames and provide a plurality of transmission frame streams to a plurality of antennas. The transceivers 226-1 to 226-N receive and process (e.g., convert to analog, amplify, filter, and frequency up-convert) each of the transmission frame streams to generate transmission signals for transmission through the antennas 230-1 to 230-N.

To transmit data, the access terminal 120 includes a transmission data processor 260, a frame builder 262, a transmission processor 264, a plurality of transceivers 266-1 to 266-M, and a plurality of antennas 270-1 to 270-M (e.g., one antenna per transceiver). The access terminal 120 may transmit data to the access point 110 on uplink and/or transmit the data to another access terminal (e.g., for peer-to-peer communication). The access terminal 120 also includes a controller 274 for controlling operations of the access terminal 120 The transceivers 266-1 to 266-M receive and process (e.g., convert to analog, amplify, filter, and frequency up-convert) an output from the transmission processor 264 for transmission via one or more of the antennas 270-1 to 270-M. For example, the transceiver 266 may up-convert the output from the transmission processor 264 into a transmission signal having a frequency in a 60 GHz band. Accordingly, the antenna module described herein may be configured to perform a beamforming operation in the 60 GHz band, for example, in a band of about 57 to 63 GHz. In addition, the antenna module may be configured to support MIMO transmission while performing beamforming in the 60 GHz band.

In relation to this, the antennas 270-1 to 270-M and the transceivers 266-1 to 266-M may be implemented in an integrated form on a multilayer circuit substrate. To do so, among the antennas 270-1 to 270-M, an antenna that operates with vertical polarization may be vertically arranged inside the multilayer circuit substrate.

To receive data, the access point 110 includes a reception (RX) processor 242 and an RX data processor 244. During operation, the transceivers 226-1 to 226-N receive a signal (e.g., from the access terminal 120) and spatially process (e.g., frequency down-convert, amplify, filter, and digitally convert) the received signal.

The reception processor 242 receives outputs from the transceivers 226-1 through 226-N and processes the outputs to recover data symbols. For example, the access point 110 may receive data from a frame (e.g., from the access terminal 120). In this example, the reception processor 242 may detect a start of the frame using the short training field (STF) sequence in a preamble of the frame. The reception processor 242 may also use the STF for automatic gain control (AGC) adjustment. The reception processor 242 may also perform channel estimation (e.g., using a channel estimation (CE) sequence in the preamble of the frame), and perform channel equalization on the received signal based on the channel estimation.

The reception data processor 244 receives the data symbols from the reception processor 242 and an indication of a corresponding MSC scheme from the controller 234, The reception data processor 244 demodulates and decodes the data symbols, recovers the data according to the indicated MSC scheme, and stores and/or outputs the recovered data (e.g., data bits) to a data sink 246 for additional processing.

The access terminal 120 may transmit the data using an orthogonal frequency-division multiplexing (OFDM) transmission mode or a single-carrier (SC) transmission mode. In this case, the reception processor 242 may process the received signal according to a selected transmission mode. In addition, as described above, the transmission processor 264 may support MIMO transmission. In this case, the access point 110 includes the plurality of antennas 230-1 to 230-N and the plurality of transceivers 226-1 to 226-N (e.g., one for each antenna). Accordingly, the antenna module described herein may be configured to perform a beamforming operation in the 60 GHz band, for example, in a band of about 57 to 63 GHz. In addition, the antenna module may be configured to support MIMO transmission while performing beamforming in the 60 GHz band.

In relation to this, the antennas 230-1 to 230-M and the transceivers 226-1 to 226-M may be implemented in an integrated form on a multilayer circuit substrate. To do so, among the antennas 230-1 to 230-M, an antenna that operates with vertical polarization may be vertically arranged inside the multilayer circuit substrate.

Meanwhile, each transceiver receives and processes (e.g., frequency down-converts, amplifies, filters, and digitally converts) a signal from each antenna. The reception processor 242 may perform spatial processing on the outputs from the transceivers 226-1 to 226-N to recover the data symbols.

The access point 110 also includes a memory 236 coupled to the controller 234. The memory 236 may store commands that, when executed by the controller 234, cause the controller 234 to perform one or more of the operations described herein. Similarly, the access terminal 120 also includes a memory 276 coupled to the controller 274. The memory 276 may store commands that, when executed by the controller 274, cause the controller 274 to perform one or more of the operations described herein.

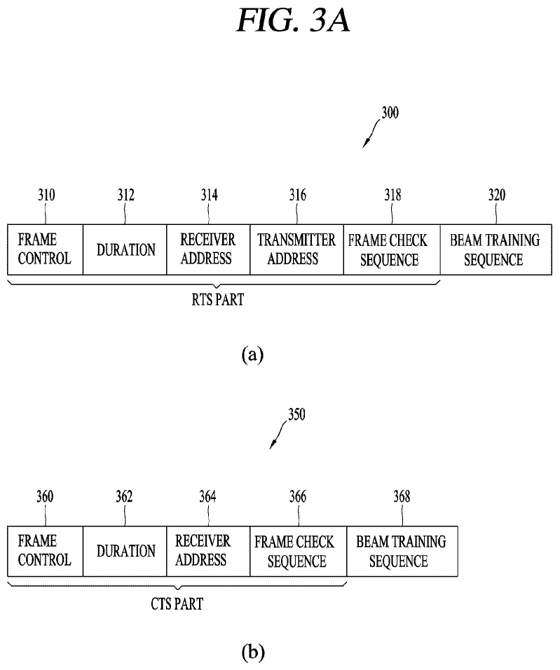

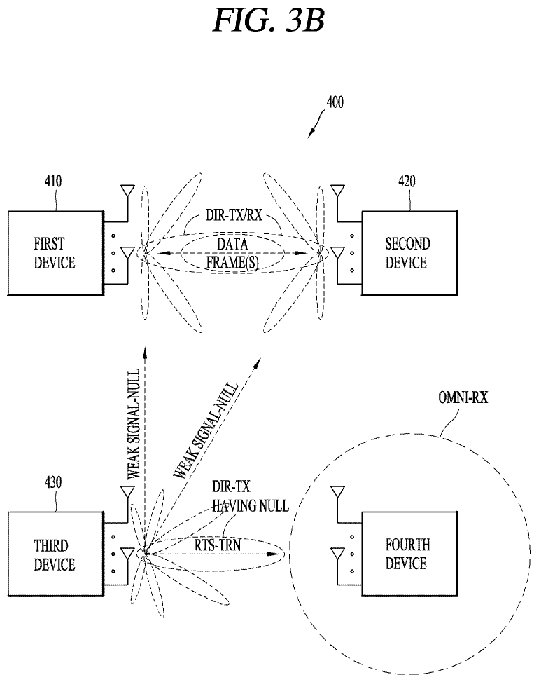

Meanwhile, an electronic device supporting the 802.11ay wireless interface described herein determines whether a communication medium may be used to communicate with another electronic device. To do so, the electronic device transmits a request-to-send (RTS)-TRN frame including an RTS part and a first beam training sequence. In relation to this, FIG. 3A illustrates a request-to-send frame (RTS) and a clear-to-send (CTS) frame according to this specification. In relation to this, a transmission device may use the RTA frame to determine whether a communication medium may be used to transmit one or more data frames to a destination device. In a response to receiving the RTS frame, the destination device transmits the CTS frame back to the transmission device when the communication medium may be used. In a response to receiving the CTS frame, the transmission device transmits one or more data frames to the destination device. In a response to successfully receiving the one or more data frames, the destination device transmits one or more acknowledgment (“ACK”) frames to the transmission device.

Referring to (a) of FIG. 3A, a frame 300 includes the RTS part including a frame control field 310, a duration field 312, a receiver address field 314, a transmitter address field 316, and a frame check sequence field 318. To improve communication and reduce interference, the frame 300 further includes a beam training sequence field 320 for configuring respective antennas of the destination device and one or more neighboring devices,

Referring to (b) of FIG. 3A, a CTS frame 350 includes a CTS part containing a frame control field 360, a duration field 362, a receiver address field 364, and a frame check sequence field 366. To improve communication and reduce interference, the frame 350 further includes a beam training sequence field 368 for configuring respective antennas of the transmission device and one or more neighboring devices.

The beam training sequence fields 320 and 368 may conform to a training (TRN) sequence according to the IEEE 802.11ad or 802.11ay standard. The transmission device may use the beam training sequence field 368 to configure an antenna of the transmission device for directional transmission to the destination device. Meanwhile, transmission devices may use the beam training sequence field to configure respective antennas of the transmission devices to prevent transmission interference at the destination device. In this case, the beam training sequence field may be used to configure the respective antennas of the transmission devices to generate an antenna radiation pattern with nulls targeting the destination device.

Accordingly, electronic devices supporting the 802.11ay wireless interface may generate an initial beam to have a low interference level with each other, using a beamforming pattern determined according to a beam training sequence. In relation to this, FIG. 3B illustrates a block diagram of a communication system 400 according to an example of this specification. As illustrated in FIG. 3B, first and second devices 410 and 420 may improve communication performance by matching directions of main beams with each other. To reduce interference with a third device 430, the first and second devices 410 and 420 may create a signal-null having a weak signal strength in a particular direction.

In relation to the generation of the main beams and the signal-null, a plurality of electronic devices described herein may be configured to perform beamforming through an array antenna. Referring to FIG. 3B, some of the electronic devices may be configured to communicate with an array antenna of another electronic device through a single antenna. In relation to this, when communication is performed through a single antenna, a beam pattern is generated as an omnidirectional pattern.

Referring to FIG. 3B, it is shown that the first to third devices 410 to 430 perform beamforming and a fourth device 440 does not perform beamforming. However, performance of beamforming is not limited thereto. Accordingly, three of the first to fourth devices 410 may be configured to perform beamforming, and the other may be configured not to perform beamforming.

As another example, only one of the first to fourth devices 410 may be configured to perform beamforming, and the other three devices may be configured not to perform beamforming. As another example, two of the first to fourth devices 410 may be configured to perform beamforming but the other two may be configured not to perform beamforming. As another example, all of the first to fourth devices 410 may be configured to perform beamforming.

Referring to FIGS. 3A and 3B, the first device 410 determines that the first device 410 is an intended receiving device for the CTS-TRN frame 350, based on an address indicated in the receiver address field 364 of the CTS-TRN frame 350. In response to the determining as being the intended receiving device for the CTS-TRN frame 350, the first device 410 may selectively use a beam training sequence in the beam training sequence field 368 of the received CTS-TRN frame 350 to configure an antenna of the first device 410 for directional transmission substantially targeting the second device 420. That is, the antenna of the first device 410 is configured to generate an antenna radiation pattern having a primary lobe (e.g., a highest gain lobe) substantially targeting the second device 420 and non-primary lobes targeting other directions.

The second device 420 is already aware of a direction toward the first device 410 on a basis of the beam training sequence of the beam training sequence field 320 in an RTS-TRN frame 300 previously received by the second device 420. Thus, the second device 420 may configure an antenna of the second device 420 selectively for directional reception targeting the first device 410 (e.g., a primary antenna radiation lobe). Therefore, while the antenna of the first device 410 is configured for the directional transmission to the second device 420 and the antenna of the second device 420 is configured for the directional reception from the first device 410, the first device 410 transmits one or more data frames to the second device 420. Accordingly, the first and second devices 410 and 420 perform directional transmission/reception DIR-TX/RX of one or more data frames through the primary lobe (the main beam).

Meanwhile, the first and second devices 410 and 420 may partially modify a beam pattern of the third device 430 to reduce interference with the third device 430 due to the antenna radiation pattern having the non-primary lobes.

In relation to this, the third device 430 determines that the third device 430 is not the intended receiving device for the CTS-TRN frame 350 on a basis of an address indicated in the receiver address field 364 of the CTS-TRN frame 350. In a response to the determining that the third device 430 is not the intended receiving device for the CTS-TRN frame 350, the third device 430 uses the beam training sequence in the beam training sequence field 368 of the received CTS-TRN 350 and a sequence of the beam training sequence field 320 in the RTS-TRN frame 300 previously received, to configure the antenna of the third device 430 to generate antenna radiation patterns having nulls substantially targeting the second device 420 and the first device 410, respectively. The nulls may be based on estimated angles of arrivals of the RTS-TRN frame 300 previously received, and the CTS-TRN frame 350. In general, the third device 430 generates antenna radiation patterns having desired signal powers, rejections or gains targeting the first device 410 and the second device 420, respectively (for example, to achieve an estimated interference in the first and second devices 410 and 420 to be equal to or less than a defined threshold value (e.g., to acquire desired BER, SNR, SINR and/or other one or more communication properties)).

The third device 430 may configure an antenna transmission radiation pattern of the third device 430 by estimating antenna gains in directions toward the first and second devices 410 and 420, estimating antenna reciprocity differences between the third device 430 and the first and second devices 410 and 420 (e.g., a transmission antenna gain minus a reception antenna gain), and respectively calculating the antenna gains and the antenna reciprocity differences throughout one or more sectors to determine estimated interferences corresponding to the first and second devices 410 and 420.

The third device 430 transmits the RTS-TRN frame 300 intended for the fourth device 440 and to be received by the fourth device 440. As long as the first and second devices 410 and 420 perform communication on a basis of durations indicated in duration fields of the duration fields 312 and 362 of the RTS-TRN frame 300 and the CTS-TRN frame 350, respectively, the third device 430 maintains an antenna configuration having nulls targeting such devices. Since the antenna of the third device 430 is configured to generate nulls targeting the first device 410 and the second device 420, transmission of the RTS-TRN frame 300 by the third device 430 may generate reduced interference in the first device 410 and the second device 420, respectively.

Accordingly, electronic devices supporting the 802.11ay wireless interface disclosed herein may configure a signal null direction in a particular direction to reduce interference while matching main beam directions with each other using an array antenna. To do so, a plurality of the electronic devices may define an initial beam direction through a beam training sequence and change a beam direction through a periodically updated beam training sequence.

As described above, for high-speed data communication between the electronic devices, beam directions should be configured to match each other. In addition, a loss of a wireless signal transmitted to an antenna element needs to be minimized for high-speed data communication. To do so, an array antenna needs to be arranged in a multilayer substrate on which a radio frequency integrated chip (RFIC) is arranged. In addition, for radiation efficiency, the array antenna needs to be arranged adjacent to a side surface region in the multilayer substrate.

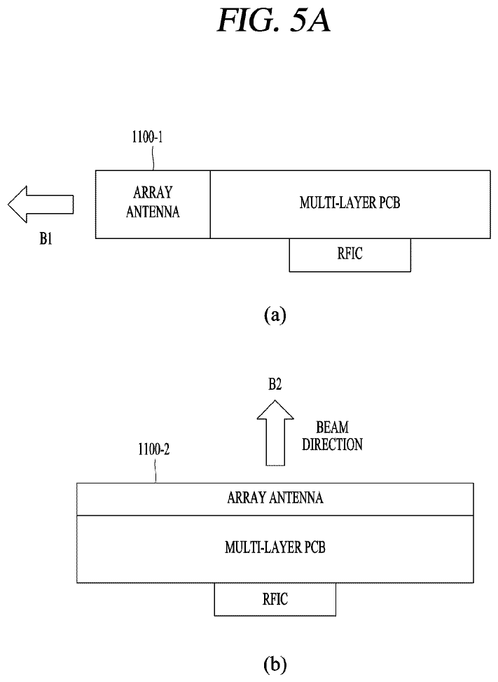

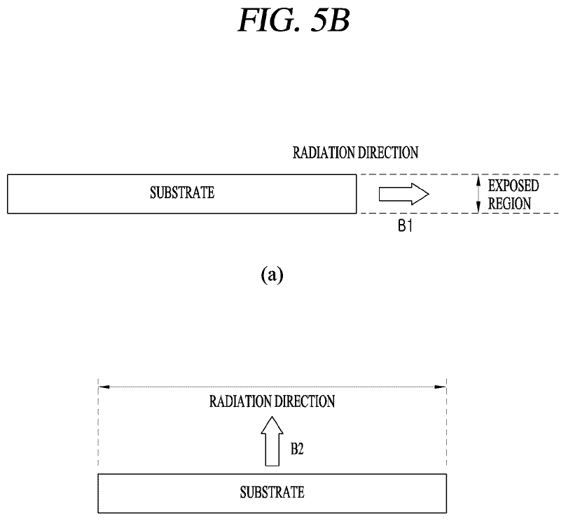

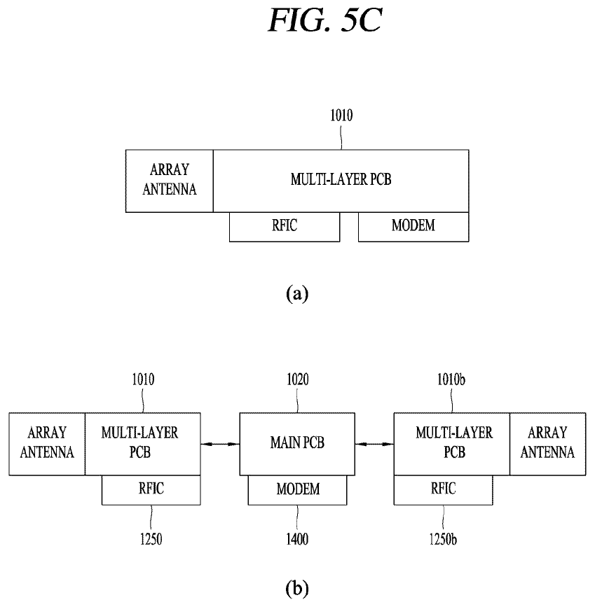

In addition, in order to adapt to a change in a wireless environment, a beam training sequence between the electronic devices needs to be updated. To update the beam training sequence, the RFIC needs to periodically transceive signals with a processor such as a modem. Therefore, to minimize update delay time, transception of a control signal between the RFIC and the modem needs to be performed within short time. To do so, a physical length of a connection path between the RFIC and the modem needs to be reduced. To do so, the modem may be arranged on a multilayer substrate on which the array antenna and the RFIC are arranged. Alternatively, a connection length between the RFIC and the modem may be configured to be minimized in a structure in which the array antenna and the RFIC are arranged on the multilayer substrate and the modem is arranged on a main substrate. In relation to this, a detailed structure will be described with reference to FIG. 5C.

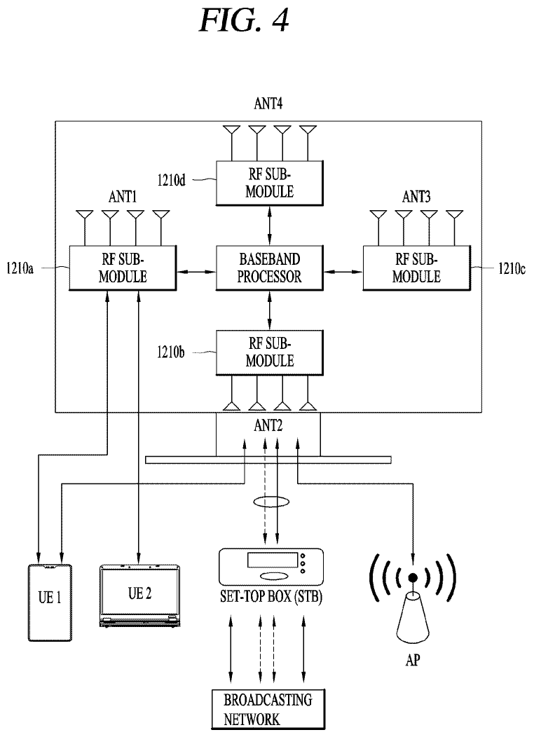

Hereinafter, an electronic device having an array antenna that may operate in a mm Wave band according to this specification will be described. In relation to this, FIG. 4 illustrates an electronic device in which a plurality of antenna modules and a plurality of transceiver circuit modules according to one embodiment are arranged. Referring to FIG. 4, a home appliance in which the plurality of antenna modules and the plurality of transceiver circuit modules are arranged may be a television, but is not limited thereto. Accordingly, in this specification, a home appliance in which the plurality of antenna modules and the plurality of transceiver circuit modules are arranged may include any home appliance or display device each configured to support a communication service in a mm Wave band.

Referring to FIG. 4, an electronic device 1000 includes a plurality of antenna modules ANT1 to ANT4 and a plurality of transceiver circuit modules 1210a to 1210d. In relation to this, the plurality of transceiver circuit modules 1210a to 1210d may correspond to a transceiver circuit 1250 as described above. Alternatively, the plurality of transceiver circuit modules 1210a to 1210d may be a partial configuration of the transceiver circuit 1250 or a partial configuration of a front end module arranged between the antenna module and the transceiver circuit 1250.

The plurality of antenna modules ANT 1 to ANT4 may be configured as an array antenna in which a plurality of antenna elements are arranged. A number of elements of the antenna modules ANT 1 to ANT4 is not limited to two, three, four, or the like as illustrated in the drawing. For example, the number of the elements of the antenna modules ANT 1 to ANT4 may extend to 2, 4, 8, 16, or the like. In addition, the elements of the antenna modules ANT 1 to ANT4 may be selected in a same number or in different numbers. The plurality of antenna modules ANT 1 to ANT4 may be arranged in different regions in a display, or in a lower portion or on a side surface of the electronic device. The plurality of antenna modules ANT 1 to ANT4 may be arranged in an upper portion, a left portion, a lower portion, or a right portion of the display. However, an arrangement structure thereof is not limited thereto. As another example, the antenna modules ANT 1 to ANT4 may be arranged in an upper left portion, an upper right portion, a lower left portion, or a lower right portion of the display.

The antenna modules ANT 1 to ANT4 may be configured to transmit or receive a signal in a particular direction in any frequency band. For example, the antenna modules ANT 1 to ANT4 may operate in any one of a 28 GHz band, a 39 GHz band, and a 64 GHz band.

The electronic device may maintain a connection state with different entities through two or more of the antenna modules ANT 1 to ANT4, or perform a data transmitting or receiving operation to maintain the connection state described above. In relation to this, the electronic device corresponding to a display device may transmit or receive data with a first entity through the first antenna module ANT1. Also, the electronic device may transmit or receive data with a second entity through the second antenna module ANT2. As an example, the electronic device may transmit or receive data to/from a mobile terminal UE through the first antenna module ANT1. The electronic device may transmit or receive data with a control device such as a set-top box or an access point (AP) through the second antenna module ANT2.

Data may be transmitted or received to/from other entities through other antenna modules, e.g., the third antenna module ANT3 and the fourth antenna module ANT4. As another example, dual connection or MIMO may be performed through at least one of the first and second entities both previously connected via the third antenna module ANT3 and the fourth antenna module ANT4.

Mobile terminals UE1 and UE2 may be arranged in a front of the electronic device, and configured to communicate with the first antenna module ANT1. Meanwhile, the set-top box STB or the access point AP may be arranged in a lower portion of the electronic device, and configured to communicate with the second antenna module ANT2, but is not limited thereto. As another example, the second antenna module ANT2 may include both a first antenna radiating toward a lower region and a second antenna radiating toward a front region. Accordingly, the second antenna module ANT2 may communicate with the set-top box STB or the access point AP through the first antenna, and with one of the mobile terminals UE1 and UE2 through the second antenna.

Meanwhile, one of the mobile terminals UE1 and UE2 may be configured to perform MIMO with the electronic device. As an example, the UE1 may be configured to perform MIMO while performing beamforming with the electronic device. As described above, the electronic device corresponding to the image display device may perform high-speed communication with another electronic device or the set-top box STB through a WiFi wireless interface. As an example, the electronic device may perform high-speed communication in a 60 GHz band with another electronic device or the set-top box STB through the 802.11ay wireless interface.

Meanwhile, the transceiver circuit modules 1210a to 1210d may operate to process a transmission signal and a reception signal in an RF frequency band. Here, the RF frequency band may be any frequency band of a millimeter band, such as a 28 GHz band, a 39 GHz band, and a 64 GHz band, as described above. The transceiver circuit modules 1210a to 1210d may be referred to as RF sub-modules 1210a to 1210d. In this case, the number of the RF sub-modules 1210a to 1210d is not limited to four, and may be changed to an arbitrary number of two or more depending on applications.

In addition, the RF sub-modules 1210a to 1210d may include an up-conversion module and a down-conversion module that convert a signal in the RF frequency band into a signal in an IF (intermediate frequency) band or convert a signal in the IF frequency band into a signal in the RF frequency band. To do so, the up-conversion module and the down-conversion module may respectively include a local oscillator (LO) capable of performing up-frequency conversion and down-frequency conversion.

Meanwhile, the plurality of RF sub-modules 1210a to 1210d may be configured such that a signal is transmitted from one module among the plurality of transceiver circuit modules to an adjacent transceiver circuit module. Accordingly, the transmitted signal may be configured to transmitted to all of the plurality of transceiver circuit modules 1210a to 1210d at least once.

To do so, a data transmission path (data transfer path) having a loop structure may be added. In relation to this, the RF sub-modules 1210b and 1210c may bidirectionally transmit a signal to an adjacent RF sub-module through a transfer path P2 having the loop structure.

Alternatively, a data transmission path having a feedback structure may be added. In relation to this, through the data transmission path having the feedback structure, at least one sub-module 1210c may transmit a signal to the other sub-modules 1210a, 1210b, and 1210c unidirectionally.

The plurality of RF sub-modules may include first to fourth RF sub-modules 1210a to 1210d. In relation to this, a signal from the first RF sub-module 1210a may be transmitted to the RF sub-module 1210b and the fourth RF sub-module 1210d both adjacent thereto. In addition, the second RF sub-module 1210b and the fourth RF sub-module 1210d may transmit the signal to the third RF sub-module 1210c adjacent thereto. At this time, when bidirectional transmission between the second RF sub-module 1210b and the third RF sub-module 1210c may be performed as shown in FIG. 4, this may be referred to as a loop structure. On the other hand, when only unidirectional transmission may be performed between the second RF sub-module 1210b and the third RF sub-module 1210c, this may be referred to as a feedback structure. Meanwhile, in the feedback structure, at least two signals may be transmitted to the third RF sub-module 1210c.

However, a structure is not limited thereto, and a baseband module may be included only in a particular module among the first to fourth RF sub-modules 1210a to 1210d depending on applications. Alternatively, depending on an application, a baseband module may not be included in the first to fourth RF sub-modules 1210a to 1210d, but may be configured as a separate controller, that is, a baseband processor 1400. For example, a control signal may be transmitted only by a separate controller, that is, the baseband processor 1400.

Meanwhile, a specific configuration and function of the electronic device illustrated in FIG. 1 and including the wireless interface of FIG. 2 will be described. Transmission or reception of data between electronic devices needs to be performed using a communication service between the electronic devices in a mm Wave band. In relation to this, a wireless audio-video (AV) service and/or high-speed data transmission may be provided using the 802.11ay wireless interface as a mm Wave wireless interface. In this case, the mmWave wireless interface is not limited to the 802.11ay wireless interface, and any wireless interface of a 60 GHz band may be adopted. In relation to this, a 5G or 6G wireless interface using a 28 GHz band or a 60 GHz band may be used for high-speed data transmission between electronic devices.

There is a problem such that, with respect to an antenna and an RFIC configured to provide a wireless interface in an electronic device such as an image display device, a specific solution for transmitting an image with a resolution of 4K or higher is not present. In particular, in consideration of a situation in which an electronic device such as an image display device is arranged on a wall of a building or on a table, wireless AV data may need to be transmitted or received to/from another electronic device. To do so, with respect to regions in which the antenna and the RFIC are to be arranged in the image display device, a specific configuration and an antenna structure need to be presented.

In this regard, FIG. 5A illustrates a configuration in which a multilayer circuit substrate on which an array antenna module is arranged is connected to an RFIC, in relation to this specification. Specifically, in relation to this specification, a structure of an antenna in package (AIP) module and an antenna module structure implemented on a flexible substrate are illustrated.

Referring to (a) of FIG. 5A, the AIP module is configured as an RFIC-PCB-antenna integrated type for mm Wave band communication. In relation to this, an array antenna module 1100-1 may be configured integrally with a multilayer substrate (a multilayer printed circuit board (PCB)) as illustrated in (a) of FIG. 5. Accordingly, the array antenna module 1100-1 configured integrally with the multilayer substrate may be referred to as an AIP module. Specifically, the array antenna module 1100-1 may be arranged in one side region of the multilayer substrate. In relation to this, a first beam B1 may be generated in a side surface region of the multilayer substrate using the array antenna module 1100-1 arranged on the one side region of the multilayer substrate.

On the other hand, referring to (b) of FIG. 5A, an array antenna module 1100-2 may be arranged on the multilayer substrate. The arrangement of the array antenna module 1100-2 is not limited to the structure of (b) of FIG. 5A, but may be performed on any layer inside the multilayer substrate. In relation to this, a second beam B2 may be generated toward a front region of the multilayer substrate using the array antenna module 1100-2 arranged on any layer of the multilayer substrate. In relation to this, in a case of the AIP module, i.e., an array antenna module provided integrally with the multilayer substrate, an array antenna may be arranged on a same PCB to minimize a distance between the RFIC and an antenna.

Meanwhile, the antenna of the AIP module may be implemented using a multilayer PCB manufacturing process, and radiate a signal in a vertical/side direction of the PCB. In relation to this, double polarization may be implemented using a patch antenna or a dipole/monopole antenna. Accordingly, the first array antenna 1100-1 shown in (a) of FIG. 5A may be arranged on a side surface region of the multilayer substrate, and the second array antenna 1100-2 shown in (b) of FIG. 5A may be arranged on a side surface region of the multilayer substrate. Therefore, the first beam B1 may be generated through the first array antenna 1100-1, and the second beam B2 may be generated through the second array antenna 1100-2.

The first array antenna 1100-1 and the second array antenna 1100-2 may be configured to have same polarization. Alternatively, the first array antenna 1100-1 and the second array antenna 1100-2 may be configured to have orthogonal polarization. In this regard, the first array antenna 1100-1 may operate as a vertically polarized antenna or operate as a horizontally polarized antenna. As an example, the first array antenna 1100-1 may be a monopole antenna having vertical polarization, and the second array antenna may be a patch antenna having horizontal polarization.

Meanwhile, FIG. 5B is a conceptual diagram illustrating antenna structures having different radiation directions.

Referring to (a) of FIG. 5A and (a) of FIG. 5B, a radiation direction of an antenna module arranged in the side region of the multilayer substrate corresponds to a side direction. In relation to this, antennas implemented on a flexible substrate may be configured as radiating elements such as a dipole/monopole antenna. That is, antennas implemented on the flexible substrate may be end-fire antenna elements.

In relation to this. end-fire radiation may be implemented by an antenna radiating in a direction horizontal to the substrate. Such an end-fire antenna may be implemented as a dipole/monopole antenna, a Yagi-dipole antenna, a Vivaldi antenna, a substrate integrated waveguide (SIW) horn antenna, or the like. In relation to this, the Yagi-dipole antenna and the Vivaldi antenna have horizontal polarization characteristics. Meanwhile, one of the antenna modules arranged in the image display device disclosed herein needs a vertically polarized antenna. Accordingly, there is a need to present an antenna structure capable of minimizing an antenna exposure region while operating as a vertically polarized antenna.

Referring to (b) of FIG. 5A and (a) of FIG. 5B, a radiation direction of the antenna module arranged on a front surface region of the multilayer substrate corresponds to a front direction. In relation to this, an antenna arranged in the AIP module may be configured as a radiating element such as a patch antenna. That is, antennas arranged in the AIP module may be broadside antenna elements radiating in a broadside direction.

Meanwhile, the multilayer substrate having the array antenna placed therein may be arranged integrally with a main substrate or may be configured to be combined with the main substrate as a modular type by a connector. In relation to this, FIG. 5C illustrates a combination structure between the multilayer substrate and the main substrate according to embodiments. Referring to (a) of FIG. 5C, a structure in which an RFIC 1250 and a modem 1400 are integrally arranged on a multilayer substrate 1010 is shown. The modem 1400 may be referred to as the baseband processor 1400. Accordingly, the multilayer substrate 1010 is arranged integrally with the main substrate. The integrated structure may be applied to a structure in which only one array antenna module is arranged in the electronic device.

On the other hand, the multilayer substrate 1010 and a main substrate 10120 may be configured to be combined with each other as a modular type by a connector. Referring to (b) of FIG. 5C, in relation to this, the multilayer substrate 1010 may be configured to interface with the main substrate 1020 through a connector. In this case, the RFIC 1250 may be arranged on the multilayer substrate 1010, and the modem 1400 may be arranged on the main substrate 1020. 39 Accordingly, the multilayer substrate 1010 may be configured as a substrate separate from the main substrate 1020 and configured to be combined with the main substrate 1020 through the connector.

Such a modular structure may be applied to a structure in which a plurality of array antenna modules are arranged in the electronic device. Referring to (b) of FIG. 5C, the multilayer substrate 1010 and a second multilayer substrate 1020 may be configured to interface with the main substrate 1020 through connector connection. The modem 1400 arranged on the main substrate 1020 is configured to be electrically coupled to RFICs 1250 and 1250b arranged on the multilayer PCB 1010 and a second multilayer PCB 1020, respectively.

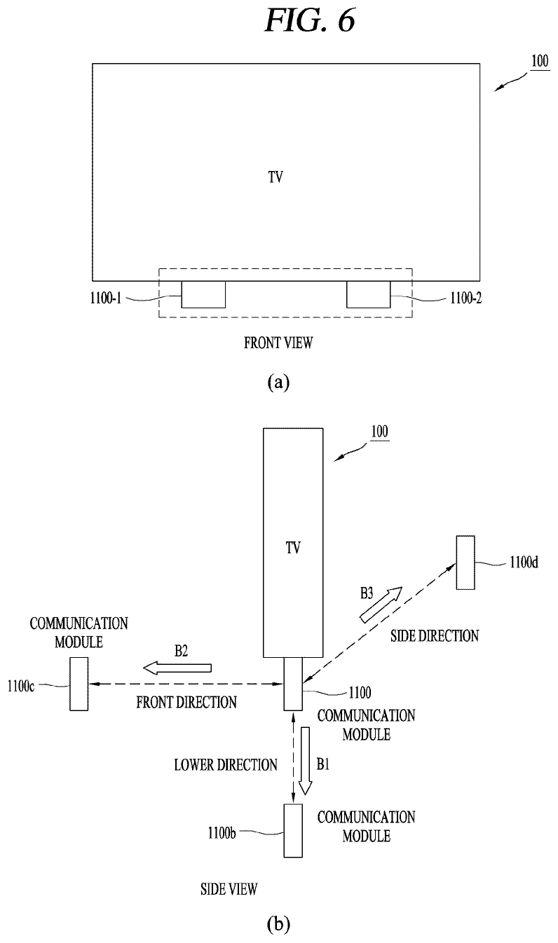

Meanwhile, when the AIP module is arranged in a lower portion of the electronic device such as an image display device, communication needs to be performed with other communication modules arranged in a lower direction and a front direction. In relation to this, FIG. 6 is a conceptual diagram illustrating a plurality of communication modules arranged in a lower portion of an image display device, a configuration of the corresponding communication modules, and communication performed between the communication modules and other communication modules arranged in a front direction. Referring to (a) of FIG. 6, different communication modules 1100-1 and 1100-2 may be arranged in a lower portion of the image display device 100. Referring to (b) of FIG. 6, the image display device 100 may perform communication with a communication module 1100b arranged therebelow through an antenna module 1100. In addition, communication may be performed with a second communication module 1100c arranged in front of the image display device 100 through the antenna module 1100 of the image display device 100. In relation to this, the communication module 1100b may be a set-top box or an access point (AP) that transmits AV data to the image display device 100 through an 802.1 lay wireless interface at a high speed, but is limited thereto. Meanwhile, the second communication module 1100c may be any electronic device that transceives data to/from the image display device 100 at a high speed through the 802.11ay wireless interface.

Meanwhile, in the AIP module structure as illustrated in (a) of FIG. 5A, an antenna height may increase depending on an RFIC driving circuit and a heat dissipation structure. Also, depending on a type of an antenna that is being used, an antenna height may increase in the AIP module structure as shown in (a) of FIG. 5A. On the other hand, in the antenna module structure implemented in a side region of the multilayer substrate as illustrated in (b) of FIG. 5A, an antenna may be implemented in a low-profile shape.

Meanwhile, a detailed configuration of the antenna modules of FIGS. 5A to 5C, which may be arranged inside or on a side surface of the electronic device of FIGS. 4 and 6, in the electronic device of FIGS. 1 to 2 and the configurations of FIGS. 3A and 3B, is to be described.

A communication module including an antenna may be arranged so that an electronic device such as an image display device may perform communication with a neighboring electronic device. Meanwhile, recently, as a display area of an image display device is enlarged, an arrangement space of a communication module including an antenna is reduced. Accordingly, there is an increasing need to arrange an antenna in a multilayer circuit substrate on which a communication module is implemented.

Meanwhile, a WiFi wireless interface may be taken into account, as an interface for a communication service between electronic devices. When such a WiFi wireless interface is used, a millimeter wave (mmWave) band may be used for high-speed data transmission between the electronic devices. In particular, high-speed data transmission between electronic devices may be performed using a wireless interface such as an 802.11ay wireless interface.

In relation to this, an array antenna capable of operating in a mmWave band may be mounted in an antenna module. However, electronic components such as an antenna and a transceiver circuit arranged in such an antenna module are configured to be electrically connected to each other. To do so, the transceiver circuit may be operably coupled to the antenna module, and the antenna module may be configured as a multilayer substrate.

As the multilayer substrate of the antenna module is arranged to have a planar stacked structure, a constraint may occur when a vertically polarized antenna is implemented. In this regard, a length of the vertically polarized antenna may be configured to be greater than a height of the multilayer substrate. Due to the constraint in the height of the multilayer substrate, there is a problem in that antenna performance may deteriorate when the vertically polarized antenna is configured to have a small length.

A horizontally polarized antennas may be designed to have a shape of a dipole antenna or a loop antenna. When a horizontally polarized antenna implemented as a dipole antenna is designed on a PCB together with a vertically polarized antenna, since overlap between structures is caused, actual implementation may not be performed easily. Even when a dual-polarized antenna is implemented to have an overlapping structure, feed lines between antennas need to be placed to be very close to each other. Accordingly, there is a problem in that great coupling occurs between antenna elements, thus significantly deteriorating antenna performance such as isolation characteristics. Therefore, there is such a problem that performance of isolation S21 cannot be improved due to coupling between antennas in an array structure of a horizontally polarized antenna having a dipole antenna structure.

An object of this specification to solve the above-mentioned problems is to provide an antenna module in which a horizontally polarized antenna operating in a mmWave band is implemented, and an electronic device including the antenna module. Another object of this specification is to propose a horizontally polarized antenna structure having a loop shape capable of sharing a space with a vertically polarized antenna. Another object of this specification is to improve isolation characteristics between antenna elements having a loop shape. Another object of this specification is to implement an end-fire antenna of a millimeter wave band, the end-fire antenna being configured to radiate from an end portion of one side of an antenna module implemented to have a multilayer substrate structure. Another object of this specification is to maintain isolation characteristics between horizontally/vertically polarized antenna elements in a structure in which the horizontally polarized antenna having a loop shape and the vertically polarized antenna having a different structure share a space in a PCB. Another object of this specification is to perform wireless communication with a peripheral electronic device by optimally arranging an antenna module on a lower portion of an electronic device.

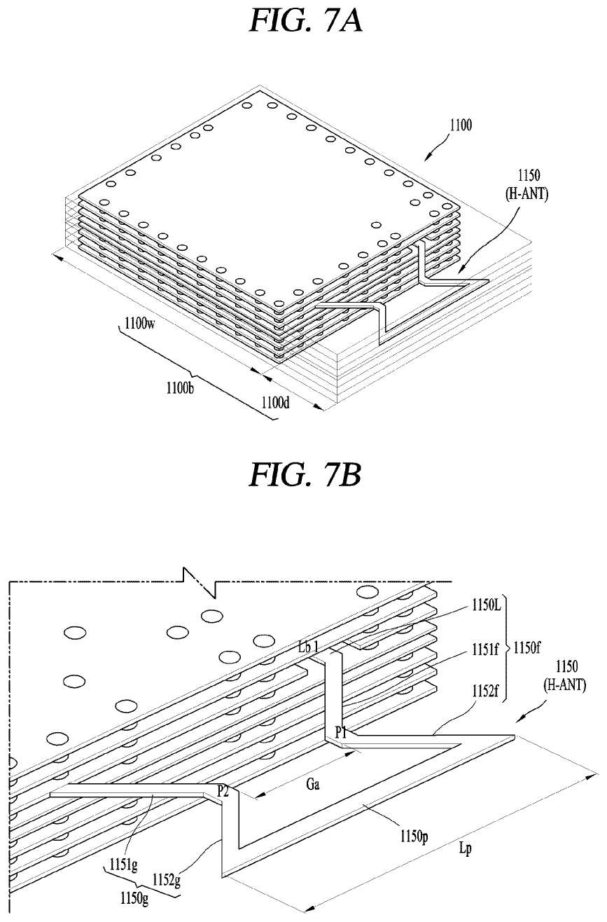

Hereinafter, an antenna module that operates in a mmWave band according to this specification, and an electronic device including the antenna module are to be described. In this regard, FIG. 7A is a perspective view of a structure in which a PCB and an FPCB each having antenna elements arranged thereon are connected to each other. FIG. 7B illustrates a structure of a horizontally polarized antenna exposed due to removal of a dielectric region of the PCB of FIG. 7A.

Referring to FIG. 7A, the antenna module 1100 may be configured to include a printed circuit board (PCB) 1100b which is a multilayer substrate. The PCB 1100b configured as a multilayer substrate structure may be combined with a flexible printed circuit board (FPCB). The PCB 1100b may be configured to include a ground wall 1100w configured to have a multilayer ground structure and a dielectric region 1100d. Respective conductive layers of the multilayer ground structure configured as the ground wall 1100w may be interconnected by a via structure, Referring to FIG. 7B, the antenna module 1100 may operate as a horizontally polarized antenna H-ANT. The horizontally polarized antenna H-ANT may be implemented as a loop antenna 1150. The horizontally polarized antenna H-ANT may be configured to include a first conductive pattern 1150f, a second conductive pattern 1150g, and a third conductive pattern 1150p. The third conductive pattern 1150p operates as a main radiator, and thus, may be referred to as a main pole. The third conductive pattern 1150p which is the main pole may be placed inside a dielectric region other than a conductor region of the PCB 1100b. The third conductive pattern 1150p is connected to the first conductive pattern 1150f and the second conductive pattern 1150g each having a concave form to thereby have a sigma(S) loop shape.

In this regard, like a differential feed scheme, configuration may be performed such that feed patterns are connected to be adjacent to both ends of the third conductive pattern 1150p and a signal applied between two feed patterns has a phase difference of 180 degrees. In this specification, the first conductive pattern 1150f is connected to a point adjacent to one end portion of the third conductive pattern 1150p, and the second conductive pattern 1150g is connected to a point adjacent to another end portion thereof.

The loop antenna 1150 having a sigma-loop shape has a structure in which end portions of the first conductive pattern 1150f and the second conductive pattern 1150g are connected to both end portions of the third conductive pattern 1150p which is the main pole. In relation to this, the first conductive pattern 1150f and the second conductive pattern 1150g may be configured to have a sigma shape with a concave structure.

The loop antenna 1150 having a sigma-loop shape may improve isolation characteristics between antenna elements through a structure of the connection to the both end portions of the third conductive pattern 1150p when implemented as an array antenna. As another example, the loop antenna 1150 having a loop shape may be implemented as a pie loop structure of connection to inner points of both end portions of the third conductive pattern 1150p.

In the PCB 1100b having a multilayer substrate structure, the third conductive pattern 1150p, which is the main pole of the antenna module 1100, may be arranged in a dielectric region (radiator region) other than a ground region including a plurality of conductive layers to operate as a radiator. The first conductive pattern 1150f and the second conductive pattern 1150g of the antenna module 1100 may also be arranged in the dielectric region (radiator region). The third conductive pattern 1150p which is the main pole is connected to the first conductive pattern 1150f and the second conductive pattern 1150g. Thus, the first conductive pattern 1150f and the second conductive pattern 1150g which constitute two sigma shapes are electrically connected to each other through the third conductive pattern 1150p which is the main pole.

Like the embodiment, the sigma shape of the loop antenna 1150 may be configured to be concave inwardly in the third conductive pattern 1150p which is the main pole, but is not limited thereto. As another example, the first conductive pattern 1150g and the second conductive pattern 1150g may be configured to be convex outwardly from the third conductive pattern 1150p which is the main pole. As still another example, the first conductive pattern 1150f and the second conductive pattern 1150g may be configured to have a concave structure and a convex structure mixed with each other.

As described above, the first conductive pattern 1150f and the second conductive pattern 1150g of a sigma-loop antenna according to this specification may be configured to have a concave structure and/or a convex structure, In this regard, FIG. 8 illustrates sigma-loop antennas configured to have concave and convex structures according to embodiments. Referring to FIGS. 7A to 8, a sigma-loop antenna 1150 operates as the horizontally polarized antenna element H-ANT.

(a) of FIG. 8 illustrates the sigma-loop antenna 1150 having a first structure in which the first conductive pattern 1150f and the second conductive pattern 1150g of first and second horizontally polarized antenna elements H-ANT1 and H-ANT2 are configured to have a concave structure. Referring to (a) of FIG. 8, the first conductive pattern 1150f may include a feed line 1150L, a first sub pattern 1151f, and a second sub pattern 1152f. One end portion of the first sub pattern 1151f is connected to the feed line 1150L, and the first sub pattern 1151f may be arranged to be inclined at a predetermined angle in a first direction. Another end portion of the first sub pattern 1151f may be arranged in an inner region. One end portion of the second sub pattern 1152f may be connected to the first sub pattern 1151f, and the second sub pattern 1152f may be arranged to be inclined at a predetermined angle in a second direction. Another end portion of the second sub pattern 1152f may be arranged in an outer region and connected to one end portion of the third conductive pattern 1150p.

The second conductive pattern 1150g may be configured to include a ground line 1150gL, a third sub pattern 1151g, and a fourth sub pattern 1152g. One end portion of the third sub pattern 1151g may be connected to the ground line 1150gL, and the third sub pattern 1151g may be arranged to be inclined at a predetermined angle in a first direction. Another end portion of the third sub pattern 1151g may be arranged in an inner region. One end portion of the fourth sub pattern 1152g is connected to the third sub pattern 1151g, and the fourth sub pattern 1152g may be arranged to be inclined at a predetermined angle in a second direction. Another end portion of the fourth sub pattern 1152g may be arranged in an outer region and connected to another end portion of the third conductive pattern 1150p.

A distance Dx in a first axial direction between the first and second horizontally polarized antenna elements H-ANT1 and H-ANT2 of the sigma-loop antenna 1150 having the first structure may be implemented as a predetermined distance or more according to the concave structure. Additionally, in the sigma-loop antenna 1150 having the first structure, sub patterns are arranged to be inclined in opposite directions. Thus, a level of coupled current has a value at a critical level or lower.

The first sub pattern 1151f of the first horizontally polarized antenna element H-ANT1 and the third sub pattern 1151g of the second horizontally polarized antenna element H-ANT2 are arranged to be inclined in opposite directions. The second sub pattern 1152f of the second horizontally polarized antenna element H-ANT1 and the fourth sub pattern 1152g of the second horizontally polarized antenna element H-ANT2 are arranged to be inclined in opposite directions. For example, the first sub pattern 1151f and the third sub pattern 1151g of adjacent antenna elements may be arranged to be inclined at −45 degrees and +45 degrees, respectively, and current directions thereof may be defined to be orthogonal to each other. In addition, the second sub pattern 1152f and the fourth sub pattern 1152g of adjacent antenna elements may be arranged to be inclined at −45 degrees and +45 degrees, respectively, and current directions thereof may be defined to be orthogonal to each other.

(b) of FIG. 8 illustrates a sigma-loop antenna 1150b having a second structure in which a feed pattern 1150fb and a ground connection pattern 1150gb of the first and second horizontally polarized antenna elements H-ANT1 and H-ANT2 are configured to have a convex structure. Referring to (b) of FIG. 8, the first conductive pattern 1150f may include the feed line 1150L, a first sub pattern 1151fb, and a second sub pattern 1152fb. One end portion of the first sub pattern 1151fb may be connected to the feed line 1150L, and the first sub pattern 1151fb may be arranged to be inclined at a predetermined angle in the second direction. Another end portion of the first sub pattern 1151fb may be arranged in an outer region. One end portion of the second sub pattern 1152fb may be connected to the first sub pattern 1151fb, and the second sub pattern 1152fb may be arranged to be inclined at a predetermined angle in a first direction. Another end portion of the second sub pattern 1152fb may be arranged in an inner region and connected to one end portion of the third conductive pattern 1150p.

The ground connection pattern 1150gb may include the ground line 1150gL, a third sub pattern 1151gb, and a fourth sub pattern 1152gb. One end portion of the third sub pattern 1151gb may be connected to the ground line 1150gL, and the third sub pattern 1151gb may be arranged to be inclined at a predetermined angle in a second direction. Another end portion of the third sub pattern 1151gb may be arranged in an outer region. One end portion of the fourth sub pattern 1152gb may be connected to the third sub pattern 1151gb, and the fourth sub pattern 1152gb may be arranged to be inclined at a predetermined angle in a first direction. Another end portion of the fourth sub pattern 1152g may be arranged in an inner region and connected to another end portion of the third conductive pattern 1150p.

A distance Dxb in a first axial direction between the first and second horizontally polarized antenna elements H-ANT1 and H-ANT2 of the sigma-loop antenna 1150b having the second structure may be implemented as a predetermined distance or less according to a convex structure. However, in the sigma-loop antenna 1150b having the second structure, sub patterns are arranged to be inclined in opposite directions. Thus, a level of coupled current may be implemented to have a value at a critical level or lower.

The first sub pattern 1151fb of the first horizontally polarized antenna element H-ANT1 and the third sub pattern 1151gb of the second horizontally polarized antenna element H-ANT2 are arranged to be inclined in opposite directions. The second sub pattern 1152fb of the second horizontally polarized antenna element H-ANT1 and the fourth sub pattern 1152gb of the second horizontally polarized antenna element H-ANT2 are arranged to be inclined in opposite directions. For example, the first sub pattern 1151fb and the third sub pattern 1151gb of adjacent antenna elements may be arranged to be inclined at +45 degrees and −45 degrees, respectively, and current directions thereof may be defined to be orthogonal to each other. In addition, the second sub pattern 1152fb and the fourth sub pattern 1152gb of adjacent antenna elements may be arranged to be inclined at +45 degrees and −45 degrees, respectively, and current directions thereof may be defined to be orthogonal to each other.

(c) of FIG. 8 illustrates a sigma-loop antenna 1150c having a second structure in which one and another among a feed pattern 1150fc and a ground connection pattern 1150gc of the first and second horizontally polarized antenna elements H-ANT1 and H-ANT2 have a convex structure and a concave structure, respectively. Referring to (c) of FIG. 8, the first conductive pattern 1150f may include the feed line 1150L, a first sub pattern 1151fc, and a second sub pattern 1152fc. One end portion of the first sub pattern 1151fb may be connected to the feed line 1150L, and the first sub pattern 1151fb may be arranged to be inclined at a predetermined angle in a second direction. Another end portion of the first sub pattern 1151fb may be arranged in an outer region. One end portion of the second sub pattern 1152fb may be connected to the first sub pattern 1151fb, and the second sub pattern 1152fb may be arranged to be inclined at a predetermined angle in a first direction. Another end portion of the second sub pattern 1152fb may be arranged in an inner region and connected to one end portion of the third conductive pattern 1150p.

The ground connection pattern 1150gc may include the ground line 1150gL, the third sub pattern 1151g, and the fourth sub pattern 1152g. One end portion of the third sub pattern 1151gmay be connected to the ground line 1150gL, and the third sub pattern 1151g may be arranged to be inclined at a predetermined angle in a first direction. Another end portion of the third sub pattern 1151g may be arranged in an inner region. One end portion of the fourth sub pattern 1152g may be connected to the third sub pattern 1151g, and the fourth sub pattern 1152g may be arranged to be inclined at a predetermined angle in a second direction. Another end portion of the fourth sub pattern 1152g may be arranged in an outer region and connected to another end portion of the third conductive pattern 1150p.

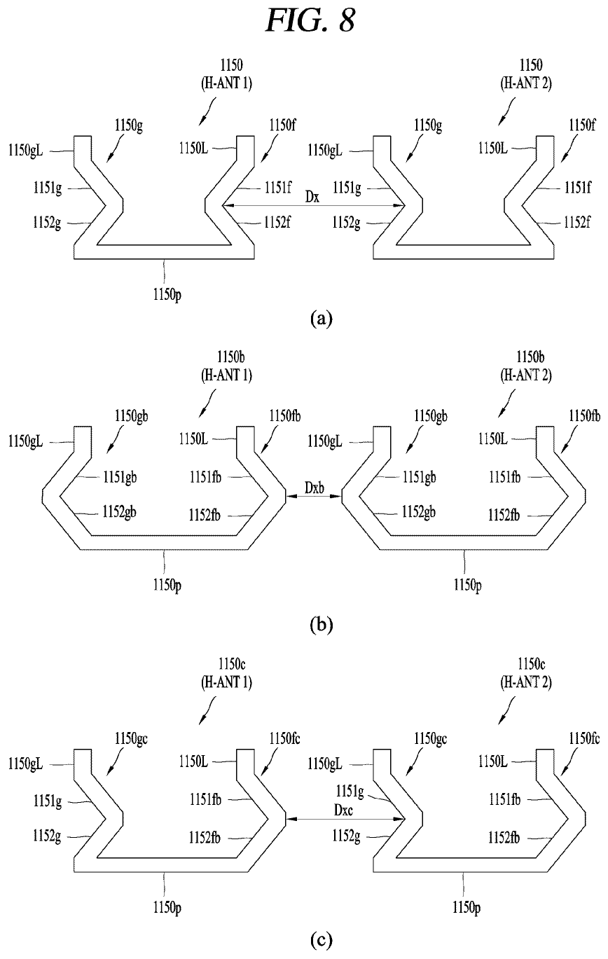

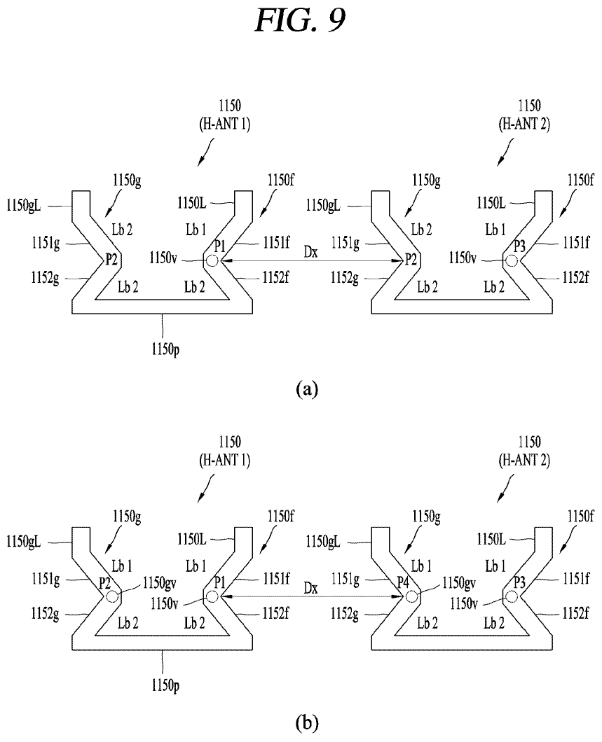

A distance Dxc in a first axial direction between the first and second horizontally polarized antenna elements H-ANT1 and H-ANT2 of the sigma-loop antenna 1150c having a third structure may be configured to be smaller than the distance Dx in the first structure and greater than the distance Dxb in the second structure. However, in the sigma-loop antenna 1150b having the third structure, sub patterns are arranged in parallel with each other to be inclined in a same direction. Thus, a level of coupled current may be at a critical level or higher. Meanwhile, a feed pattern and/or a ground connection pattern of a sigma-loop antenna according to this specification may be configured such that conductive patterns of different layers are connected to each other by a via structure. In this regard, FIG. 9 illustrates structures in which feed patterns and/or ground connection patterns according to embodiments are connected to each other by a via structure. (a) of FIG. 9 illustrates a structure in which the first and second sub patterns 1151f and 1152f of the feed pattern 1150 are connected to each other by a feed via 1150v. Referring to (a) of FIG. 9, the first and second sub patterns 1151f and 1152f of the first and second horizontally polarized antenna elements H-ANT1 and H-ANT2 may be connected to each other through the feed via 1150v of first and third connection points P1 and P3. The first and second sub patterns 1151f and 1152f may be arranged on first and second layers Lb1 and Lb2 of a PCB, respectively. The first sub pattern 1151f of the first conductive pattern 1150f may be arranged on a first sub-layer Lb1, and other conductive patterns may be arranged on a second sub-layer Lb2.

(b) of FIG. 9 illustrates a structure in which the first and second sub patterns 1151f and 1152f of the feed pattern 1150 are connected to each other by the feed via 1150v and the third and fourth sub patterns 1151g and 1152g thereof are connected to each other by a ground via 1150g V. Referring to (b) of FIG. 9, the first and second sub patterns 1151f and 1152f of the first and second horizontally polarized antenna elements H-ANT1 and H-ANT2 may be connected to each other through the feed via 1150v of the first and third connection points P1 and P3. The first and second sub patterns 1151f and 1152f may be arranged on the first and second layers Lb1 and Lb2 of a PCB, respectively. The third and fourth sub patterns 1151g and 1152g of the first and second horizontally polarized antenna elements H-ANT1 and H-ANT2 may be connected to each other through the ground via 1150gv of second and fourth connection points P2 and P4. The third and fourth sub patterns 1151g and 1152g may be arranged on the first and second layers Lb1 and Lb2 of the PCB, respectively. The first sub pattern 1151f of the first conductive pattern 1150f and the third sub pattern 1151g of the second conductive pattern 1150g may be arranged on the first sub-layer Lb1, and other conductive patterns may be arranged on the second sub-layer Lb2.

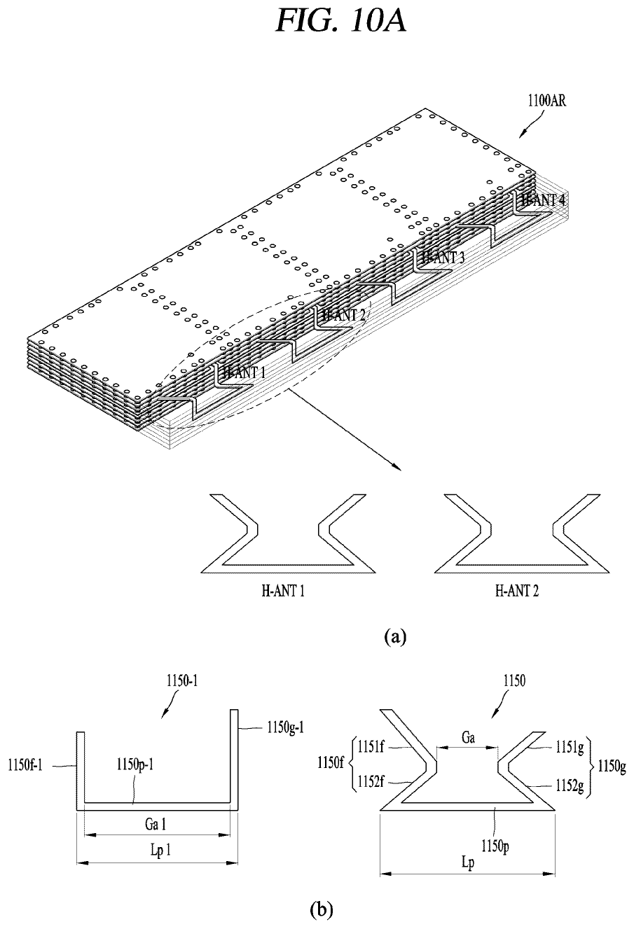

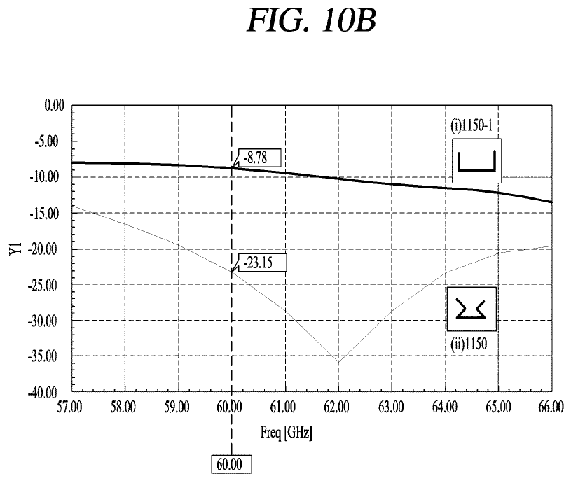

Meanwhile, an antenna element having a sigma-loop structure according to this specification may be arranged in plurality to constitute an array antenna structure. Additionally, a shape of the antenna element having the sigma-loop structure may be modified variously depending on applications. In this regard, FIG. 10A illustrates an array antenna constituted by antenna elements having a sigma-loop structure according to this specification and a shape of each antenna element. (a) of FIG. 10A is an enlarged view of an array antenna constituted by antenna elements having a sigma-loop structure according to this specification and each antenna element. (b) of FIG. 10A illustrates shapes of antenna elements according to different loop structures. FIG. 10B shows a comparison between isolation characteristics between antenna elements according to different loop structures in the array antenna of FIG. 10A.

Referring to (a) of FIG. 10A, a plurality of antenna elements may be arranged in a first axial direction to constitute an array antenna 1100AR. The first horizontally polarized antenna element H-ANT1 to a fourth horizontally polarized antenna element H-ANT4 of the array antenna 1100AR may be configured to radiate a beamformed wireless signal having horizontal polarization in a first axial direction. In this regard, since isolation S21 between two antennas in the array antenna 1100AR affects gain performance of the array antenna, when the isolation is fine, performance of the array antenna is improved.

Referring to (b) of FIG. 10A, a length Lp1 of a conductive pattern 1150p-1 of an antenna element 1150-1 having a loop shape of a first structure may be configured to be equal to a sum of widths of a feed pattern 1150f-1 and a ground connection pattern 1150g-1 and a space Gal therebetween. The antenna element 1150 having a sigma-loop shape of a second structure may be configured to include the first conductive pattern 1150f, the second conductive pattern 1150g, and the third conductive pattern 1150p. The first conductive pattern 1150f may be configured to include the first sub pattern 1151f and the second sub pattern 1152f. The second conductive pattern 1150g may be configured to include the third sub pattern 1151g and the fourth sub pattern 1152g.

A length Lp of the third conductive pattern 1150p of the antenna element 1150 having a sigma-loop shape of the second structure may be configured to be greater than a space Ga between the first conductive pattern 1150f and the second conductive pattern 1150g. A whole length of the antenna element 1150 of a sigma-loop shape of the second structure may be configured to be smaller than a whole length of the antenna element 1150-1 of a loop shape of the first structure.

Referring to FIGS. 10A and 10B, the isolation S21 between adjacent antenna elements in the array antenna may affect gain performance of the array antenna. When isolation between antenna elements improves, performance of the array antenna may also improve. FIG. 9B shows a comparison between (i) isolation S21 between adjacent antenna elements 1150-1 in the array antenna and (ii) isolation S21 between adjacent antenna elements 1150 in the array antenna.

As performance of the isolation S21 between adjacent antenna elements in the array antenna is improved, antenna performance of the array antenna may be improved. In this regard, the isolation S21 of the antenna element 1150-1 having a loop shape of the first structure has a value of approximately −8.8 dB at 60 GHz. The isolation S21 of the antenna element 1150 of a sigma-loop shape of the second structure has an isolation characteristic with a value of about −23.1 dB at 60 GHz, which shows an improvement by about 15 dB compared to that of the first structure.

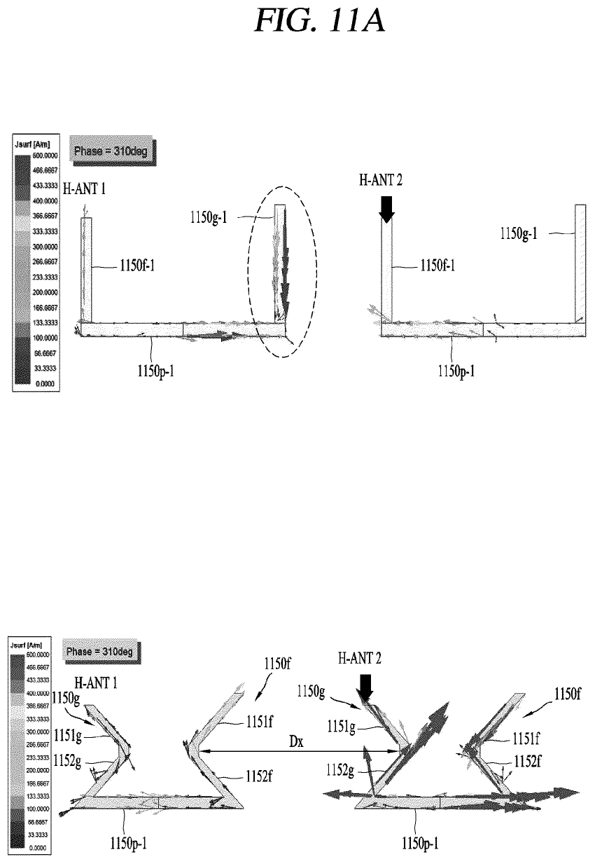

Hereinafter, a principle of improvement of isolation is described by comparing current distributions of an antenna having a loop shape of the first structure and an antenna having a sigma-loop shape of the second structure according to this specification. In this regard, FIG. 11A illustrates a current distribution of an antenna having a loop shape of the first structure. FIG. 11B illustrates a current distribution of an antenna having a sigma-loop shape of the second structure.

FIG. 11A shows a current distribution generated in a first antenna element P1 when a signal is only applied to feed power to a second antenna element P2 among the first antenna element Pl and the second antenna element P2 in the first structure having a loop shape. Referring to (b) of FIG. 9A and FIG. 10A, when power is applied to the feed pattern 1150f-1 of the second antenna element P2 of the first structure having a loop shape, strong coupling at a critical level or higher occurs to the first antenna element P1 arranged in parallel. Accordingly, a current is coupled to the ground connection pattern 1150g-1 of the first antenna element Pl adjacent to the feed pattern 1150f-1 of the second antenna element P2 at the critical level or higher. Therefore, a characteristic of the isolation S21 deteriorates as the current of the second antenna element P2 is coupled to the first antenna element P1.

FIG. 11B shows a current distribution generated in the first antenna element P1 when a signal is only applied to feed power to the second antenna element P2 among the first antenna element Pl and the second antenna element P2 in the second structure having a sigma-loop shape. Referring to (b) of FIG. 9A and FIG. 10B, the antenna element 1150 having a sigma-loop shape of the second structure may be configured to include the first conductive pattern 1150f, the second conductive pattern 1150g, and the third conductive pattern 1150p. The first conductive pattern 1150f may be configured to include the first sub pattern 1151f and the second sub pattern 1152f. The second conductive pattern 1150g may be configured to include the third sub pattern 1151g and the fourth sub pattern 1152g.

Even when power is applied to the second antenna element P2 of the second structure, an amount of current coupled to the first antenna element P1 is significantly reduced. In this regard, as a distance Dx between the first conductive pattern 1150f of the second antenna element P2 and the second conductive pattern 1150g of the first antenna element Pl increases, an amount of coupled current is significantly reduced. Thus, an amount of current generated in the second antenna element P2 of the second structure having a sigma-loop shape is configured to be greater than an amount of current generated in the second antenna element P2 of the first structure. Accordingly, performance of isolation between adjacent antenna elements of the second structure having a sigma-loop shape is improved, and radiation performance such as antenna efficiency is also improved.

Even when power is applied to the first conductive pattern 1150f of the second antenna element P2 in the sigma-loop antenna of FIG. 11B, a direction of current is generated differently from a direction in the ground pattern 1150g of the first antenna element PI adjacent thereto. Accordingly, antenna elements in the sigma-loop antenna of FIG. 11B are spaced further apart from each other compared to antenna elements in the loop antenna of FIG. 11A. Accordingly, it may be checked that in the second structure having the sigma-loop shape of FIG. 11B, an amount of current coupled to the first antenna element P1 is small, and an amount of current flowing to the second antenna element P2 is great. Therefore, in the second structure of the sigma-loop shape, both performance of the isolation S21 and antenna radiation performance are improved. In summary, when power is applied to the first conductive pattern 1150f of the second antenna element P2 of the second structure having the sigma-loop shape, a weak coupling less than a critical level occurs to the first antenna element PI arranged in parallel. A current is coupled to the second conductive pattern 1150g of the first antenna element PI adjacent to the first conductive pattern 1150f of the second antenna element P2 at the critical level or higher. Therefore, as a level of current of the second antenna element P2 coupled to the first antenna element P1 is reduced, isolation characteristics are improved.

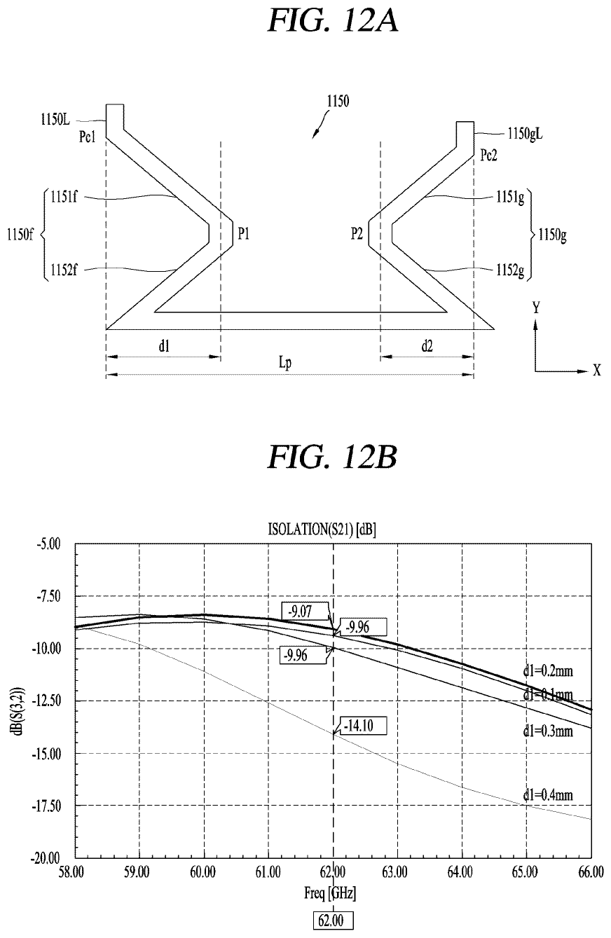

Meanwhile, a feed pattern of a horizontally polarized antenna according to this specification may be arranged on a plurality of layers in consideration of an arrangement structure of a vertically polarized antenna. On the other hand, a ground connection pattern of the horizontally polarized antenna according to this specification may be arranged on a single layer or a plurality of layers. In this regard, FIG. 12A illustrates a structure in which a sigma-loop antenna according to this specification is configured to be concave inwardly. FIG. 12B shows a comparison between isolation characteristics according to a distance at which a feed pattern and a ground connection pattern are arranged inwardly in the sigma-loop antenna of FIG. 12A.

Referring to FIG. 12A, the sigma-loop antenna 1150 may be configured to include the first conductive pattern 1150f, the second conductive pattern 1150g, and the third conductive pattern 1150p. The first conductive pattern 1150f may be configured to include the first sub pattern 1151f and the second sub pattern 1152f. The first sub pattern 1151f may be arranged from an outer side toward an inner side to be inclined at a predetermined angle in a first axial direction. The second sub pattern 1152f may be connected to the first sub pattern 1151f at the first connection point P1 on a first axis. The second sub pattern 1152f may be arranged from an inner side toward an outer side to be inclined at a predetermined angle in the first axial direction.

The second conductive pattern 1150g may be configured to include the third sub pattern 1151g and the fourth sub pattern 1152g. The third sub pattern 1151g may be arranged from an outer side toward an inner side to be inclined at a predetermined angle in the first axial direction. The fourth sub pattern 1152g may be connected to the third sub pattern 1151g at the first connection point P2 on the first axis. The fourth sub pattern 1152g may be arranged from an inner side toward an outer side to be inclined at a predetermined angle in the first axial direction.

The first conductive pattern 1150f may be further include the feed line 1150L connected to the first sub pattern 1151f. The second conductive pattern 1150g may further include the ground line 1150gL connected to the third sub pattern 1151g. One end portion of the first sub pattern 1151f may be connected to the feed line 1150L at a first point Pc1 on a second axis. One end portion of the third sub pattern 1151g may be connected to a second point Pc2 on the second axis of the ground line 1150gL. The first point Pc1 may be a further inner point in a PCB compared to the second point Pc2. In this regard, the first axis and the second axis may be set as an x-axis and a y-axis of FIG. 11A.

The first conductive pattern 1150f and the ground pattern 1150g are arranged concavely to a certain level or higher. Thus, when a plurality of antenna elements are arranged adjacent to each other, a level of mutual interference may be reduced. In this regard, a degree of concaveness of the loop antenna 1150 having a sigma-loop shape may be defined by a distances dl or d2 from one end portion of the first conductive pattern 1150f or the ground pattern 1150g to another end portion thereof connected to the third conductive pattern 1150p corresponding to a main pole. A degree of concaveness or convexity of the loop antenna 1150 having a sigma-loop shape may be determined by the distance d1 or d2. With respect to the distance d1 and d2, as the first and second connection points P1 and P2 are arranged at an inner or outer side of the third conductive pattern 1150p, the loop antenna 1150 is configured to have a concave or convex structure.

The distance d1, in the first axial direction, from one end portion of the first sub pattern 1151f to another end portion of the first sub pattern 1151f located at the first connection point P1 may be configured as 0.06λ₀<d1< a half of a length Lp of the third conductive pattern 1150p. The distance d2, in the first axial direction, from one end portion of the third sub pattern 1151g to another end portion of the third sub pattern 1153g located at the second connection point P2 may be configured as 0.06 λ₀<d2< a half of the length Lp of the third conductive pattern 1150p. The distances d1 and d2 in the first axial direction are distances for which the first conductive pattern 1150f and the second conductive pattern 1150g are arranged inwardly in the sigma-loop antenna 1150, respectively. Here, No represents a wavelength of a signal propagating in air, for example, a wavelength of a signal at 60 GHz.

With reference to 60 GHz, 0.06 λ₀ corresponds to 0.3 mm. Accordingly, the distances dl and d2 for which the first conductive pattern 1150f and the second conductive pattern 1150g are arranged inwardly may be determined as being 0.3 mm or more, respectively. Additionally, the distance d1 and d2 for which the first conductive pattern 1150f and the second conductive pattern 1150g are arranged inwardly may be determined as being half or less the length Lp of the third conductive pattern 1150p.

Referring to FIG. 7C, FIG. 12A, and FIG. 12B, when the distance d1 for which the first conductive pattern 1150f is arranged inwardly is 0.1 mm and 0.2 mm, isolation S21 at 62 GHz is determined as −9.4 dB and −9.1 dB, respectively. Meanwhile, when the distance d1 for which the first conductive pattern 1150f is arranged inwardly is 0.3 mm, the isolation S21 is −10 dB, which shows an improvement of performance. In addition, it may be checked that when the distance d1 for which the first conductive pattern 1150f is arranged inwardly is 0.4 mm, the isolation S21 is increased to −-14.1 dB by approximately 5 dB.

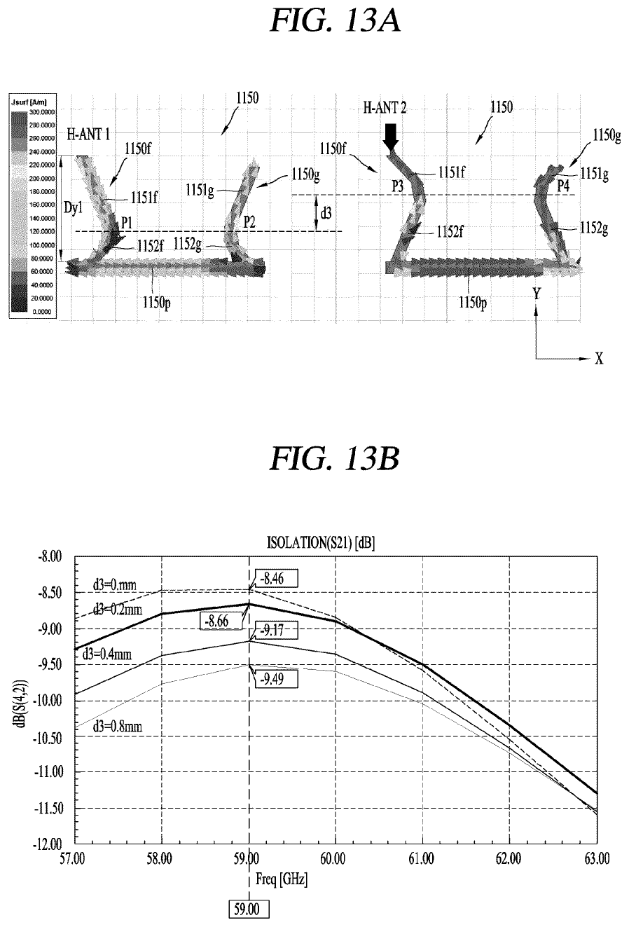

Meanwhile, points at which a feed pattern and a ground connection pattern of a sigma-loop antenna operating as a horizontally polarized antenna according to this specification are configured to be concave inwardly may be configured to have an asymmetric structure. In this regard, FIG. 13A illustrates a structure in which points at which sigma-loop antenna elements are configured to be concave are misaligned in a second axial direction. FIG. 13B shows isolation characteristics according to a distance in correspondence with the misalignment of FIG. 13A.

Referring to FIG. 13A, the sigma-loop antenna 1150 may be configured to include the first conductive pattern 1150f, the second conductive pattern 1150g, and the third conductive pattern 1150p. The first conductive pattern 1150f may be configured to include the first sub pattern 1151f and the second sub pattern 1152f. The second conductive pattern 1150g may be configured to include the third sub pattern 1151g and the fourth sub pattern 1152g.

In a sigma-loop antenna structure which is concavely configured, the second antenna element H-ANT2 may be placed at a position close to the second point P2 of the first antenna element H-ANT1. In the structure, a position of the second point P2 of the first antenna element H-ANT1 and a position of the third point P3 of the second antenna element H-ANT2 may be misaligned. Accordingly, even when current is applied to the second antenna element H-ANT2, a level of current coupled to the first antenna element H-ANTI may be configured to be at a critical level or lower. A strong current distribution is generated in the second antenna element H-ANT2 to which a signal is applied. Thus, high antenna efficiency is obtained. On the other hand, a current distribution at a critical level or lower is generated in the first antenna element H-ANT1 to which a signal is not applied. Thus, a mutual interference level is reduced, thereby improving isolation characteristics.

Shapes of the first antenna element H-ANTI and the second antenna element H-ANT2 may be configured differently. Inner points of the first antenna element H-ANT1 and the second antenna element H-ANT2 may be arranged to be spaced apart from each other by a predetermined distance d3 in the second axial direction. The second conductive pattern 1150g of the first antenna element H-ANT1 may be connected at the second point P2. The first conductive pattern 1150f of the second antenna element H-ANT2 may be connected at the second point P3. The third point P3 may be arranged in a further inner region in the PCB compared to the first point P2. With respect to a misalignment level, a distance d3 from the second point P2 to the third point P3 on a second axis may be configured as 0.04 λ₀ or greater. The distance d3 from the second point P2 to the third point P3 may be determined as 0.04 λ₀<d3<min (0.5*Dy1, 0.5*Dy2). In this regard, min (A, B) may be defined as a minimum value of A and B. Here, Dyl represents a length of the first conductive pattern 1150f in the second axial direction, and Dy2 represents a length of the second conductive pattern 1150g in the second axial direction.

Referring to FIGS. 13A and 13B, the distance d3 corresponding to a misalignment level may be increased to 0, 0.2, 0.4, and 0.8 mm, respectively. It may be checked that as the distance d3 increases from 0, 0.2, 0.4, to 0.8 mm, isolation is improved from −8.4 dB to −9.5 dB at 59 GHZ by about 1.1 dB, respectively.

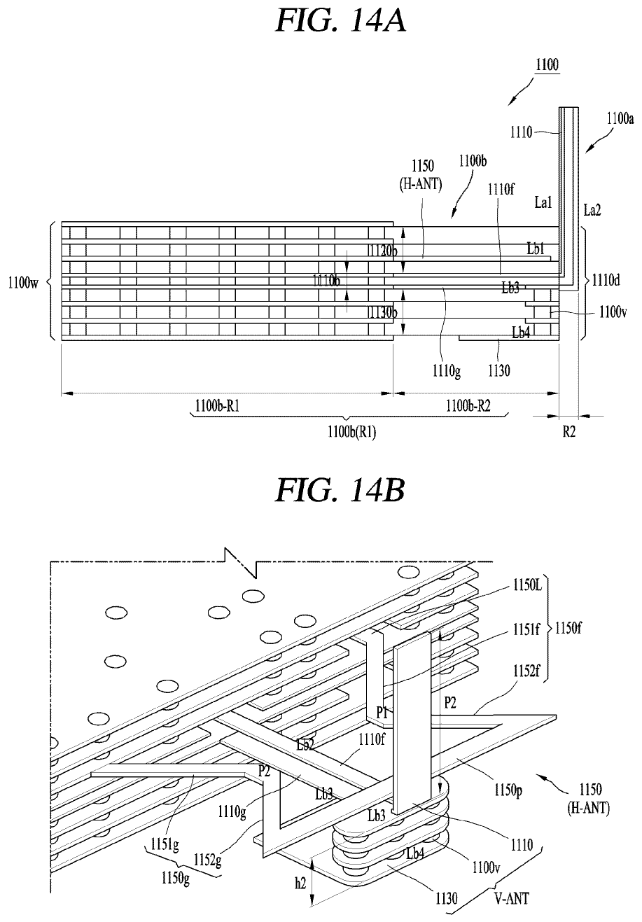

Meanwhile, a horizontally polarized antenna having a sigma-loop shape according to this specification may constitute a dual-polarized antenna together with a vertically polarized antenna arranged on a PCB and an FPCB. In this regard, FIG. 14A is a side view of a dual-polarized antenna structure in which a PCB is connected to an FPCB, FIG. 14B illustrates a structure of the dual-polarized antenna exposed due to removal of a dielectric region of the PCB of FIG. 14A.

Referring to FIG. 14A, the antenna module 1100 may be configured to include a flexible printed circuit board (FPCB) 1100a and a printed circuit board (PCB) 1100b which is a multilayer substrate. The FPCB 1100a may include a plurality of layers. The FPCB 1100a may include a fourth conductive pattern 1110 arranged on a first layer La1, and a second layer La2. The PCB 1100b may be configured to include the ground wall 1100w configured to have a multilayer ground structure and the dielectric region 1100d. A dual-polarized antenna including the horizontally polarized antenna H-ANT and the vertically polarized antenna V-ANT may be implemented in the dielectric region 1100d. The horizontally polarized antenna H-ANT may be placed on a single layer of the first sub-layer Lb1 of the PCB 1100b.

Referring to FIGS. 14A and 14B, the antenna module 1100 may operate as a dual-polarized antenna including the horizontally polarized antenna H-ANT and the vertically polarized antenna V-ANT. In this regard, the horizontally polarized antenna H-ANT implemented as a sigma-loop antenna needs to be implemented in a layout structure to be capable of operating independently without deterioration of performance of the sigma-loop antenna even when the vertically polarized antenna V-ANT is arranged. The horizontally polarized antenna H-ANT implemented as a sigma-loop antenna is placed to overlap the vertically polarized antenna V-ANT. In this regard, a phenomenon of occurrence of mutual coupling may be avoided by spacing feed lines of the horizontal/vertical antenna elements to be apart from each other at a certain level or more.

Meanwhile, in a structure in which a feed line 1110f of the vertically polarized antenna V-ANT and the first conductive pattern 1150f of the horizontally polarized antenna H-ANT are arranged on a same layer, overlapping with the third conductive pattern 1150p which is a main pole of the horizontally polarized antenna H-ANT may occur. Therefore, overlapping between the feed line 1110f of the vertically polarized antenna V-ANT and the horizontally polarized antenna H-ANT needs to be prevented. In this regard, the horizontally polarized antenna H-ANT may be arranged on the first sub-layer Lb1 of the PCB 1100b. The feed line 1110f and a fifth conductive pattern 1110g of the vertically polarized antenna V-ANT may be arranged on layers other than the first sub-layer Lb1. For example, the feed line 1110f and the fifth conductive pattern 1110g of the vertically polarized antenna V-ANT may be arranged on the second sub-layer Lb2 and a third sub-layer Lb3, respectively.

The horizontally polarized antenna H-ANT may be implemented as the loop antenna 1150, for example, a sigma-loop antenna in which the first conductive pattern 1150f and the second conductive pattern 1150g are arranged concavely toward an inner region. The horizontally polarized antenna H-ANT may be configured to include the first conductive pattern 1150f, the second conductive pattern 1150g, and the third conductive pattern 1150p. The first conductive pattern 1150f may be configured to include the feed line 1150L and the first and second sub patterns 1151f and 1152. The second conductive pattern 1150g may be configured to include the third and fourth sub patterns 1151g and 1152g. The first and second sub patterns 1151f and 1152 may be arranged to be inclined at a predetermined angle in the first direction and the second direction, respectively, and end portions thereof may be connected at the first connection point P1. The third and fourth sub patterns 1151g and 1152g are arranged to be inclined at a predetermined angle in the first direction and the second direction, respectively, and ends thereof may be connected at the second connection point P2.

The vertically polarized antenna V-ANT may be configured to include the fourth conductive pattern 1110, a via structure 1110v, and a sixth conductive pattern 1130. The fourth conductive pattern 1110 may be configured to have a first height h1. The via structure 1110v may be configured to have a second height h2 that is less than the first height h1. The fourth conductive pattern 1110 may be connected to the feed line 1110f. The via structure 1110v and the sixth conductive pattern 1130 may be connected to the fifth conductive pattern 1110g.

Hereinafter, an antenna module implemented as a horizontally polarized antenna having a sigma-loop structure according to this specification is described with reference to FIGS. 7A to 14B. The antenna module 1000 may be constituted by the multilayer substrates (multi-layered substrates) 1100a and 1100b made of a plurality of dielectric materials, and conductive patterns. The FPCB 1100a and the PCB 1100b may be implemented as the multilayer substrates (multi-layered substrates). The multilayer substrates 1100a and 1100b may be configured to include a first layer 1110b, second layers 1120b, and third layers 1130b.

The first layer 1110b may be made of a flexible first material. The second layers 1120b may include a plurality of layers made of a rigid second material arranged on one side surface of the first layer 1110b. The third layers 1130b may include a plurality of layers made of the rigid second material arranged on another side surface of the first layer 1110b. The first layer 1110b may be placed between the second layers 1120b and the third layers 1130b of the multilayer substrates 1100a and 1100b.

The first layer 1110b may include a first region RI arranged in parallel with the second layers 1120b and the third layers 1130b and a second region R2 arranged vertically to the second layers 1120b and the third layers 1130b. The first region R1 may be a PCB region and the second region R2 may be an FPCB region.

Conductive patterns of the antenna module 1000 may include the first conductive pattern 1150f, the second conductive pattern 1150g, and the third conductive pattern 1150p to operate as a horizontally polarized antenna. The first conductive pattern 1150f may be arranged on the first sub-layer Lb1 which is one layer among the second layers 1120b. The second conductive pattern 1150g may be arranged on the first sub-layer Lb1 to be spaced apart from the first conductive pattern 1150f. The third conductive pattern 1150p may be configured to be connected to the first conductive pattern 1150f and the second conductive pattern 1150g.

A distance between the first conductive pattern 1150f and the second conductive pattern 1150g may be configured to increase or decrease in one axial direction. Accordingly, the first conductive pattern 1150f and the second conductive pattern 1150g may be configured to be convex or concave. As shown in FIG. 7C, a structure in which the first conductive pattern 1150f and the second conductive pattern 1150g are configured to be concave may be referred to as a sigma-loop antenna. In this regard, the first conductive pattern 1150f and the second conductive pattern 1150g may be each configured to include a plurality of sub patterns.

The first conductive pattern 1150f may be configured to include the first sub pattern 1151f and the second sub pattern 1152f. The second conductive pattern 1150g may be configured to include the third sub pattern 1151g and the fourth sub pattern 1152g. The first sub pattern 1151f may be connected to the feed line 1150L of a multilayer substrate. The second sub pattern 1152f may be connected to the ground line 1150gL of the multilayer substrate. A distance Ga between the first connection point Pl between the first sub pattern 1151f and the second sub pattern 1152f and the second connection point P2 between the third sub pattern 1151g and the fourth sub pattern 1152g may be configured to be different from a length Lp of the conductive pattern 1150.

As an example, the first sub pattern 1151f may be arranged as a straight line or a curve to be inclined toward an inner region with reference to the feed line 1150L. The second sub pattern 1151f may be arranged as a straight line or a curve to be inclined toward an outer region with reference to the feed line 1150L. The third sub pattern 1151g may be arranged as a straight line or a curve to be inclined toward an inner region with reference to the ground line 1150gL. The fourth sub pattern 1152g may be arranged as a straight line or a curve to be inclined toward an outer region with reference to the ground line 1150gL. A length of the third conductive pattern 1150p may be configured to be greater than a space in a gap between the first connection point P1 between the first sub pattern 1151f and the second sub pattern 1152f and the second connection point P2 between the third sub pattern 1151g and the fourth sub pattern 1152g.

As another example, the first sub pattern 1151f may be arranged as a straight line or a curve to be inclined toward an outer region with reference to the feed line 1150L. The second sub pattern 1151f may be arranged as a straight line or a curve to be inclined toward an inner region with reference to the feed line 1150L. The third sub pattern 1151g may be arranged as a straight line or a curve to be inclined toward an outer region with reference to the ground line 1150gL. The fourth sub pattern 1152g may be arranged as a straight line or a curve to be inclined toward an inner region with reference to the ground line 1150gL. A length of the third conductive pattern 1150p may be configured to be smaller than a space in a gap between the first connection point P1 between the first sub pattern 1151f and the second sub pattern 1152f and the second connection point P2 between the third sub pattern 1151g and the fourth sub pattern 1152g.

The conductive patterns of the antenna module 1000 may further include the fourth conductive pattern 1110 that operates as a vertically polarized antenna. Accordingly, the antenna module 1000 may be implemented as a dual-polarized antenna that operates as a horizontally polarized antenna and a vertically polarized antenna. The fourth conductive pattern 1110 arranged in the first region R1 implemented as the FPCB 1100a may be arranged in a middle region between the first conductive pattern 1150f and the second conductive pattern 1150g.

A multilayer substrate configured as the PCB 1100b may include the ground wall 1100w. The ground wall 1100w may be arranged on respective layers including a front layer and a rear layer of the PCB 1100b. The ground wall 1100w may be configured such that conductive patterns are connected between a plurality of dielectric layers of the PCB 1100b through ground vias. The feed line 1150L connected to the first sub pattern 1151f may be arranged between ground patterns within the ground wall 1100w to constitute a coplanar waveguide (CPW) feed structure.

The first conductive pattern 1150f and the ground pattern 1150g are arranged concavely to a certain level or higher. Thus, when a plurality of antenna elements are arranged adjacent to each other, a level of mutual interference may be reduced. In this regard, the distance d1, in a first axial direction, from one end portion of the first sub pattern 1151f to another end portion of the first sub pattern 1151f located at the first connection point Pl may be configured as 0.062λ₀<d1< a half of a length of the third conductive pattern 1150p. The distance d2, in the first axial direction, from one end portion of the third sub pattern 1151g to another end portion of the third sub pattern 1153g located at the second connection point P2 may be configured as 0.06 λ₀<d2< a half of the length Lp of the third conductive pattern 1150p. Here, No represents a wavelength of a signal propagating in air, for example, a wavelength of a signal at 60 GHz.

By configuring lengths of the first conductive pattern 1150f and the ground pattern 1150g to be different from each other, isolation characteristics, i.e., a level of mutual interference may be improved when a plurality of antenna elements are arranged to be adjacent to each other. In this regard, a length of the first sub pattern 1151f of the first conductive pattern 1150f may be configured to be greater than a length of the third sub pattern 1151g of the ground pattern 1150g. A first point Pc1 on a second axis of the feed line 1150L connected to one end portion of the first sub pattern 1151f may be a further inner point in the PCB 1110b compared to a second point Pc2 on a second axis of the ground line 1150gL connected to one end portion of the third sub pattern 1151g.

As another example, a length of the first sub pattern 1151f of the first conductive pattern 1150f may be configured to be smaller than a length of the third sub pattern 1151g of the ground pattern 1150g. The second point Pc2 on the second axis of the ground line 1150gL connected to one end portion of the third sub pattern 1151g may be a further inner point in the PCB 1110b compared to the first point Pc1 on the second axis of the feed line 1150L connected to one end portion of the first sub pattern 1151f.

Meanwhile, points at which the first conductive pattern 1150f and the ground pattern 1150g are bent may be configured as a same point in the second axial direction. In this regard, the first connection point P1 between the first sub pattern 1151f and the second sub pattern 1152f and the second connection point P2 between the third sub pattern 1151g and the fourth sub pattern 1152g may be arranged at a same point in the second axial direction perpendicular to the first axial direction. As another example, by configuring points at which the first conductive pattern 1150f and the ground pattern 1150g are bent to be different from each other in the second axial direction, isolation characteristics, i.e., a level of mutual interference may be improved when a plurality of antenna elements are arranged to be adjacent to each other.

The PCB 1100b may be divided into a first region 1100b-R1 and a second region 1100b-R2 with reference to an end portion of a region in which the ground wall 1100w is arranged. Accordingly, the PCB 1100b may be configured to include a first region 1100b-R1 and a second region 1100b-R2. The ground wall 1100w is placed in the first region 1100b-R1 such that the first region 1100b-R1 constitutes a ground region of the PCB 1100b. The second region 1100b-R2 in which a ground wall is not placed constitutes a dielectric region or a radiator region. The antenna element 1150 including the first conductive pattern 1150f, the second conductive pattern 1150g, and the third conductive pattern 1150p may be arranged in the second region 1100b-R2. A distance Ga between the first connection point Pl and the second connection point P2 may be configured to be smaller than a length Lp of the third conductive pattern 1150p. Accordingly, the antenna element 1150 having a loop antenna shape may be referred to as a sigma-loop antenna.

A sum of lengths of respective components of the antenna element 1150 configured as a sigma-loop antenna may be configured to be within a predetermined range with reference to an operating wavelength of a specific frequency of an operating frequency band. Accordingly, an electrical length of the antenna element 1150 including the first conductive pattern 1150f, the second conductive pattern 1150g, and the third conductive pattern 1150p may be set to be within a predetermined range with reference to one time an operating wavelength λg corresponding to an operating frequency.

As described above, the antenna element 1150 implemented as a loop antenna according to this specification operates as the horizontally polarized antenna H-ANT. The antenna module 1100 may be configured to further include the vertically polarized antenna V-ANT in addition to the horizontally polarized antenna H-ANT. The vertically polarized antenna V-ANT may include the fourth conductive pattern 1110 vertically connected to the feed pattern 1110f arranged on the second sub-layer Lb2 different from the first sub-layer Lb1 to extend to an upper region. The fourth conductive pattern 1110 may be arranged on the first layer Lal of the FPCB 1100a of the antenna module 1000.

The vertically polarized antenna V-ANT may further include the fifth conductive pattern 1110g and the sixth conductive pattern 1130. The fifth conductive pattern 1110g may be arranged on a layer different from that of the feed line 1110f. The sixth conductive pattern 1130 may be connected to the fifth conductive pattern 1110g through the via structure 1100v to have a C shape. The fifth conductive pattern 1110g may be arranged on the third sub-layer Lb3 which is one layer among the third layers 1130b. The sixth conductive pattern 1130 may be arranged on a fourth sub-layer Lb4, which is another layer among the third layers 1130b. The fifth conductive pattern 1110g and the sixth conductive pattern 1130 may be connected to each other by the via structure 1100v. The via structure 1100v may include via holes arranged in a plurality of rows and stacked vertically.

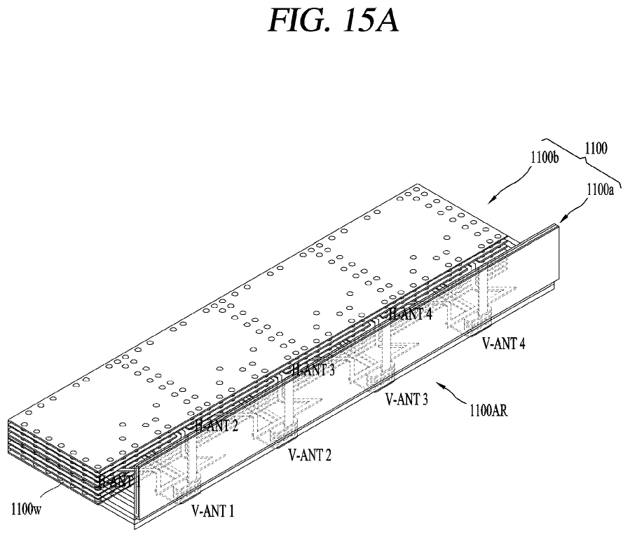

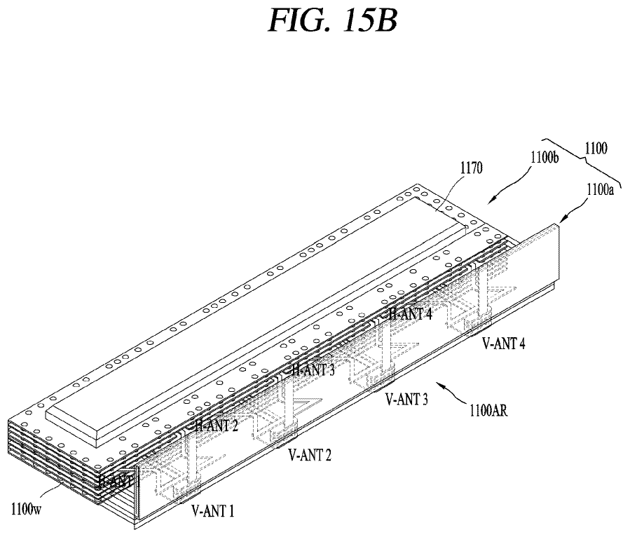

Meanwhile, an antenna module implemented as a dual-polarized antenna according to this specification may be implemented as an array antenna. In this regard, FIG. 15A illustrates an antenna module in which a horizontally polarized antenna implemented as a sigma-loop antenna and a vertically polarized antenna are implemented as a dual polarized array antenna. FIG. 15B illustrates a structure in which a shield can is arranged on an upper portion of a PCB of the antenna module of FIG. 15A.

Referring to FIGS. 15A and 15B, the antenna module 1100 may be configured to include the FPCB 1100a and the PCB 1100b. The array antenna 1100AR implemented as a dual polarized end-fire antenna may improve a gain of the array antenna by using components placed on an upper portion of the PCB 1100b. In this regard, a shield can 1170 may be placed on an upper portion of the ground wall 1100w of the PCB 1100b. A conductive region in a lower portion of the shield can 1170 may be configured to be connected to a conductive layer of the ground wall 1100w of the PCB 1100b.

The array antenna 1100AR may be arranged on the dielectric region 1100d of a front surface portion of the ground wall 1100w on which the shield can 1170 is placed. The array antenna 1100AR may include the first horizontally polarized antenna element H-ANT1 to the fourth horizontally polarized antenna element H-ANT4 arranged to be spaced apart from each other in a first axial direction. The array antenna 1100AR may include a first vertically polarized antenna element V-ANT1 to a fourth vertically polarized antenna element V-ANT4 spaced apart from each other in the first axial direction. The first horizontally polarized antenna element H-ANT1 to the fourth horizontally polarized antenna element H-ANT4 may be arranged such that adjacent elements are spaced apart from each other by a first space in the first axial direction. The first vertically polarized antenna element V-ANTI to the fourth vertically polarized antenna element V-ANT4 may be also arranged such that adjacent elements are spaced apart from each other by the first space in the first axial direction.

The first horizontally polarized antenna element H-ANT1 to the fourth horizontally polarized antenna element H-ANT4 constitute a first array antenna to radiate a beam-formed wireless signal having horizontal polarization toward one side direction of the PCB 1100b. The first vertically polarized antenna element V-ANT1 to the fourth vertically polarized antenna element V-ANT4 constitute a second array antenna to radiate a beam-formed wireless signal having vertical polarization toward one side direction of the PCB 1100b. The first and second array antennas may be implemented as a dual-polarized end-fire antenna that simultaneously radiate a horizontally polarized signal and a vertically polarized signal toward a side direction. Therefore, a multiple input/output (MIMO) operation or a diversity operation may be performed by simultaneously transmitting or receiving signals of a same frequency band through the first and second array antennas.

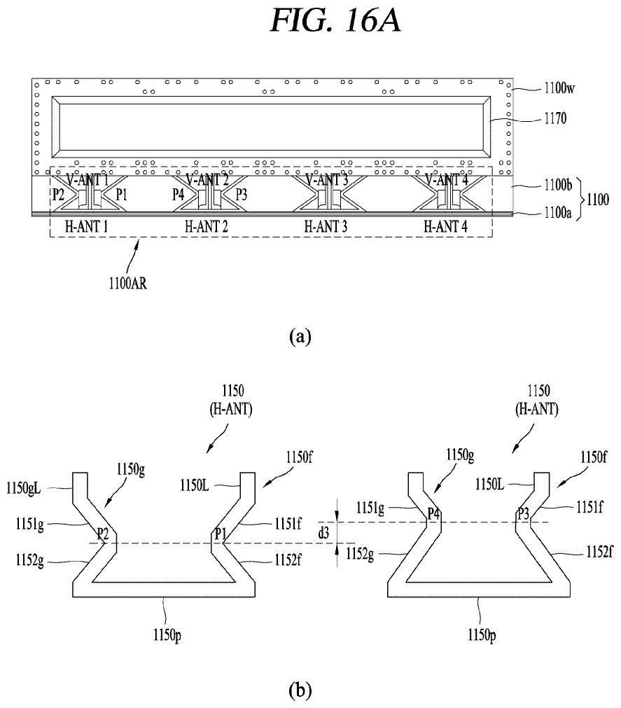

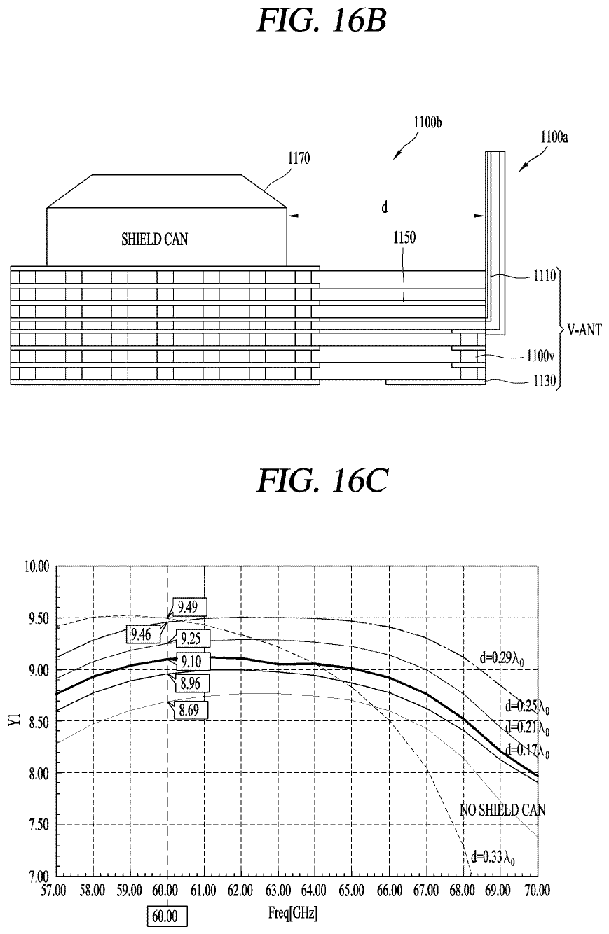

Meanwhile, FIG. 16A illustrates a front view of an array antenna module in which the shield can of FIG. 15B is arranged and an enlarged view of a sigma-loop antenna. FIG. 16B is a side view of the array antenna module in which the shield can of FIG. 16A is arranged.

Referring to (a) of FIG. 16A, the antenna module 1100 may include the FPCB 1100a and the PCB 1100b. The first to fourth vertically polarized antenna elements V-ANTI to V-ANT4 may be arranged on the FPCB 1100a and the PCB 1100b. The first to fourth horizontally polarized antenna elements H-ANT1 to H-ANT4 may be arranged on the PCB 1100b. The shield can 1170 may be arranged on the ground wall 1100w of the PCB 1100b.

Referring to (a) of FIG. 16A, the first and second horizontally polarized antenna elements H-ANT1 and H-ANT2 arranged adjacent to each other may be configured to have a same shape. Accordingly, the horizontally polarized antenna elements of the array antenna 1100AR may be arranged such that connection points at which the horizontally polarized antenna elements are bent are aligned with each other. The first connection point P1 of a feed pattern of the first horizontally polarized antenna element H-ANT1 and the third connection point P3 of a feed pattern of the second vertically polarized antenna element H-ANT2 may be arranged at a same point on a second axis. The second connection point P2 of a ground connection pattern of the first horizontally polarized antenna element H-ANT1 and the fourth connection point P4 of a ground connection pattern of the second vertically polarized antenna element H-ANT2 may be arranged at a same point on the second axis.

As another example, referring to (b) of FIG. 16A, the first and second horizontally polarized antenna elements H-ANT1 and H-ANT2 arranged adjacent to each other may be configured to have different shapes. In this regard, the first connection point P1 of the first conductive pattern 1150f of the first horizontally polarized antenna element H-ANT1 and the third connection point P3 of the first conductive pattern 1150f of the second vertically polarized antenna element H-ANT2 may be spaced apart from each other by a distance d3 on the second axis. Additionally, the second connection point P2 of the second conductive pattern 1150g of the first horizontally polarized antenna element H-ANT1 and the fourth connection point P4 of the second conductive pattern 1150g of the second vertically polarized antenna element H-ANT2 may be spaced apart from each other by a distance d4 on the second axis, Referring to FIG. 13A and (b) of FIG. 16A, the horizontally polarized antenna elements of the array antenna 1100AR may be arranged such that connection points at which the horizontally polarized antenna elements are bent are misaligned with each other. In this regard, connection points between the first conductive pattern 1150f and the ground connection pattern 1150g of the first horizontally polarized antenna H-ANT1 and the second horizontally polarized antenna H-ANT2 of the array antenna 1100AR may be configured to be different from each other. Sub patterns constituting the first conductive pattern 1150f of the first horizontally polarized antenna H-ANT1 may be connected at the first point P1 in a second axial direction. Sub patterns constituting ground connection patterns 1150g of the first horizontally polarized antenna H-ANT1 may be connected at the second point P2 in the second axial direction. Sub patterns constituting the first conductive pattern 1150f of the second horizontally polarized antenna H-ANT2 may be connected at a third point P3 in the second axial direction. Sub patterns connecting ground connection patterns 1150g of the second horizontally polarized antenna H-ANT2 may be connected at the third point in the second axial direction. The third point P3 may be configured as a point different from the first point P2 in the second axial direction. Accordingly, shapes of the first horizontally polarized antenna H-ANT1 and the second horizontally polarized antenna H-ANT2 may be configured to be different from each other. The third point P3 may be arranged in a further inner region in the PCB 1100b compared to the second point P2. A distance d3 from the second point P1 to the third point P3 may be configured to be 0.04 λ₀ or greater.

Referring to FIGS. 15A to 16B, the shield can 1170 may be arranged on an upper portion of the PCB 1100b on which a 1×4 dual-polarized end-fire array antenna is implemented. The shield can 1170 may be implemented as a metal case, but is not limited thereto. An array antenna gain may be improved using components mounted on the PCB 1100b of the dual-polarized end-fire array antenna.

For example, when it is assumed that a component mounted on the PCB 1100b is the shield can 1170, the shield can 1170 may be arranged on the upper portion of the PCB 1100b. The shield can 1170 may be attached to the ground wall 1100w of the PCB 1100b, and the dual-polarized end-fire array antenna may be placed in portion in front of the shield can 1170. An antenna gain of the array antenna varies depending on a distance d between the shield can 1170 and the antenna. Here, d may be defined as a distance from the shield can 1170 to the first conductive pattern 1100 of the vertically polarized antenna arranged on the FPCB.

A plurality of antenna elements may be arranged in a first axial direction to constitute the array antenna 1100AR. The first horizontally polarized antenna element H-ANT1 to the fourth horizontally polarized antenna element H-ANT4 of the array antenna 1100AR may be configured to radiate a beamformed first wireless signal having horizontal polarization in a first axial direction. The first vertically polarized antenna element V-ANT1 to the fourth vertically polarized antenna element V-ANT1 of the array antenna 1100AR may be configured to radiate a beamformed second wireless signal having vertical polarization in the first axial direction.

As described above, the antenna module 1100 may further include the shield can 1170 arranged on a ground pattern in an upper portion of the ground wall 1100w of the PCB 1100b. Gain characteristics of the array antenna may be changed depending on a distance d from the shield can 1170 to the fourth conductive pattern 1110 arranged on the FPCB 1100a. In this regard, FIG. 16C shows gain characteristics of a horizontally polarized antenna according to a distance from an end portion of the shield can of FIGS. 16A and 16B to a vertically polarized antenna in the array antenna structure in which the shield can is arranged.

Referring to FIGS. 16A to 16C, a change in a gain of a 1×4 sigma-loop array antenna according to a change in the distance d to the shield can in a frequency band of 57 to 70 GHz is shown. A structure having only a 1×4 array antenna arranged therein without a shield can has an antenna gain of about 8.7 dB. Other than a structure in which the distance d to the shield can is d =0.33 λ₀, all structures of the horizontally polarized antenna have an antenna gain improved over that of a structure without a shield can. Accordingly, the distance d between the shield can 1170 and the first conductive pattern 1110 arranged on the FPCB 1100a may be configured to be in a range of (0.17+n)*λ₀<d<(0.33+n)*π₀. Here, n may be 0 or a natural number.

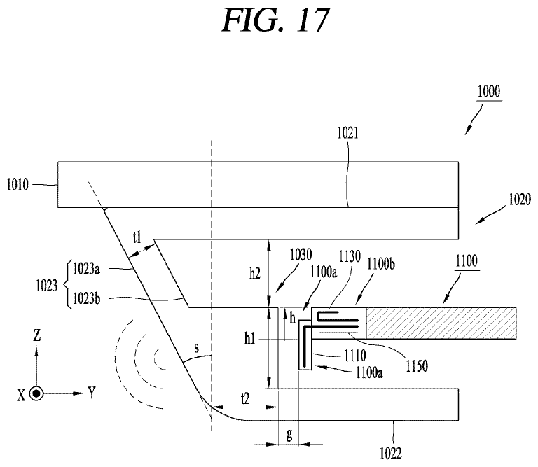

An antenna module implemented as a dual-polarized antenna according to one aspect of this specification has been described above. Hereinafter, an electronic device having an antenna module implemented as a dual-polarized antenna according to another aspect of this specification is to be described. In this regard, all the technical features and configurations described above also apply to a description to be provided hereinafter. FIG. 17 illustrates an electronic device having an antenna module arranged in a dielectric case according to this specification.

Referring to FIG. 17, the antenna module 1000 may be arranged inside a mechanical structure such as a dielectric case 1020 of a metal frame 1010 of an electronic device having a display. In this regard, a rear surface of the PCB 1100b of the antenna module 1000 may be arranged to face the metal frame 1010 so that a rear surface of the antenna module 1000 is directed toward the metal frame 1010.

To minimize an interference of the metal frame 1010, it is advantageous for the fourth conductive pattern 1110 which is an upper-end pole to be directed toward an opposite direction to the metal frame 1010, that is, toward a lower end. Accordingly, the sixth conductive pattern 1130, which is an inverted C-shaped lower-end pole, may be arranged to be adjacent to the metal frame 1010.

Referring to FIGS. 1 to 17, the electronic device 1000 may be configured to include the metal frame 1010, the dielectric case 1020, and the antenna module 1100. The metal frame 1010 may be configured to constitute a side surface region of the electronic device 1000. The metal frame 1010 may be arranged to surround a display and configured to support the display. The dielectric case 1020 may be located on one side of the metal frame 1010. The dielectric case 1020 may be arranged on one side surface constituting a lower region of the metal frame 1010. The dielectric case 1020 may be configured to have a first height h1 in correspondence with a region in which the antenna module 1100 is arranged. An air layer 1030 may be configured to have a second height h2 in an upper region of the dielectric case 1020.

The antenna module 1100 may be arranged in an inner region of the dielectric case 1020. The antenna module 1100 may be arranged to face an inner surface 1023 of the dielectric case 1020 and include the multilayer substrates 1100a and 1100b made of a plurality of dielectric materials and a conductive pattern. The dielectric case 1020 may include a front surface portion 1021 attached to the metal frame 1020, a rear surface portion 1022 corresponding to the front surface portion 1021, and a side surface portion 1023 arranged between the front surface portion 1021 and the rear surface portion 1022. The antenna module 1000 may be configured to include the FPCB 1100a and the PCB 1100b. The antenna module 1000 may include a horizontally polarized antenna implemented as the loop antenna 1150 on a particular layer of the PCB 1100b. The antenna module 1000 may further include a vertically polarized antenna including the fourth conductive pattern 1110 implemented on the FPCB 1100a and the sixth conductive pattern 1130 implemented on the PCB 1100b.

The multilayer substrates 1100a and 1100b may be configured to include the first layer 1110b, the second layers 1120b, and the third layers 1130b. The first layer 1110b may be made of a flexible first material. The second layers 1120b may include a plurality of layers made of a rigid second material arranged on one side surface of the first layer 1110b. The third layers 1130b may include a plurality of layers made of the rigid second material arranged on another side surface of the first layer 1110b. The first layer 1110b may be placed between the second layers 1120b and the third layers 1130b of the multilayer substrates 1100a and 1100b.

The first layer 1110b may include the first region R1 arranged in parallel with the second layers 1120b and the third layers 1130b and the second region R2 arranged vertically to the second layers 1120b and the third layers 1130b. The first region R1 may be a PCB region and the second region R2 may be an FPCB region.

Conductive patterns of the antenna module 1000 may include the first conductive pattern 1150f, the second conductive pattern 1150g, and the third conductive pattern 1150p to operate as a horizontally polarized antenna. The first conductive pattern 1150f may be arranged on the first sub-layer Lb1 which is one layer among the second layers 1120b. The second conductive pattern 1150g may be arranged on the first sub-layer Lb1 to be spaced apart from the first conductive pattern 1150f. The third conductive pattern 1150p may be configured to be connected to the first conductive pattern 1150f and the second conductive pattern 1150g.

The first conductive pattern 1150f may be configured to include the first sub pattern 1151f and the second sub pattern 1152f. The second conductive pattern 1150g may be configured to include the third sub pattern 1151g and the fourth sub pattern 1152g. The first sub pattern 1151f may be connected to the feed line 1150L of the multilayer substrate. The second sub pattern 1152f may be connected to the ground line 1150 gL of the multilayer substrate. A distance Ga between the first connection point P1 between the first sub pattern 1151f and the second sub pattern 1152f and the second connection point P2 between the third sub pattern 1151g and the fourth sub pattern 1152g may be configured to be different from a length Lp of the conductive pattern 1150.

As an example, the first sub pattern 1151f may be arranged as a straight line or a curve to be inclined toward an inner region with reference to the feed line 1150L. The second sub pattern 1151f may be arranged as a straight line or a curve to be inclined toward an outer region with reference to the feed line 1150L. The third sub pattern 1151g may be arranged as a straight line or a curve to be inclined toward an inner region with reference to the ground line 1150gL. The fourth sub pattern 1152g may be arranged as a straight line or a curve to be inclined toward an outer region with reference to the ground line 1150gL. A length of the third conductive pattern 1150p may be configured to be greater than a space in a gap between the first connection point P1 between the first sub pattern 1151f and the second sub pattern 1152f and the second connection point P2 between the third sub pattern 1151g and the fourth sub pattern 1152g.

As another example, the first sub pattern 1151f may be arranged as a straight line or a curve to be inclined toward an outer region with reference to the feed line 1150L. The second sub pattern 1151f may be arranged as a straight line or a curve to be inclined toward an inner region with reference to the feed line 1150L. The third sub pattern 1151g may be arranged as a straight line or a curve to be inclined toward an outer region with reference to the ground line 1150gL. The fourth sub pattern 1152g may be arranged as a straight line or a curve to be inclined toward an inner region with reference to the ground line 1150gL. A length of the third conductive pattern 1150p may be configured to be smaller than a space in a gap between the first connection point PI between the first sub pattern 1151f and the second sub pattern 1152f and the second connection point P2 between the third sub pattern 1151g and the fourth sub pattern 1152g.

A multilayer substrate configured as the PCB 1100b may include the ground wall 1100w. The first conductive pattern 1150f may further include the feed line 1150L arranged within the ground wall 1100w and connected to the first sub pattern 1151f. The feed line 1150L may be arranged between ground patterns within the ground wall 1100w to constitute a CPW feed structure.

The distance d1, in a first axial direction, from one end portion of the first sub pattern 1151f to another end portion of the first sub pattern 1151f located at the first connection point P1 may be configured as 0.06 λ₀<d1< a half of a length Lp of the third conductive pattern 1150p. The distance d2, in the first axial direction, from one end portion of the third sub pattern 1151g to another end portion of the second sub pattern located at the second connection point P2 may be configured as 0.06 λ₀<d2 < a half of the length Lp of the third conductive pattern 1150p.

A length of the first sub pattern 1151f may be configured to be greater than a length of the third sub pattern 1151g. A first point Pc1 on a second axis of the feed line 1150L connected to one end portion of the first sub pattern 1151f may be a further inner point in the PCB 1100b compared to a second point Pc2 on a second axis of the ground line 1150gL connected to one end portion of the third sub pattern 1151g. The first connection point P1 between the first sub pattern 1151f and the second sub pattern 1152f and the second connection point P2 between the third sub pattern 1151g and the fourth sub pattern 1152g may be arranged at a same point in a second axial direction perpendicular to the first axial direction.

The PCB 1100b may include a first region 1100b-R1 in which the ground wall 1100w is arranged. The PCB 1100b may include a second region 1100b-R2 in which antenna elements including the first conductive pattern 1150f, the second conductive pattern 1150g, and the third conductive pattern 1150p are arranged. An electrical length of an antenna element including the first conductive pattern 1150f, the second conductive pattern 1150g, and the third conductive pattern 1150p may be set to be within a predetermined range with reference to one time an operating wavelength Ag corresponding to an operating frequency.

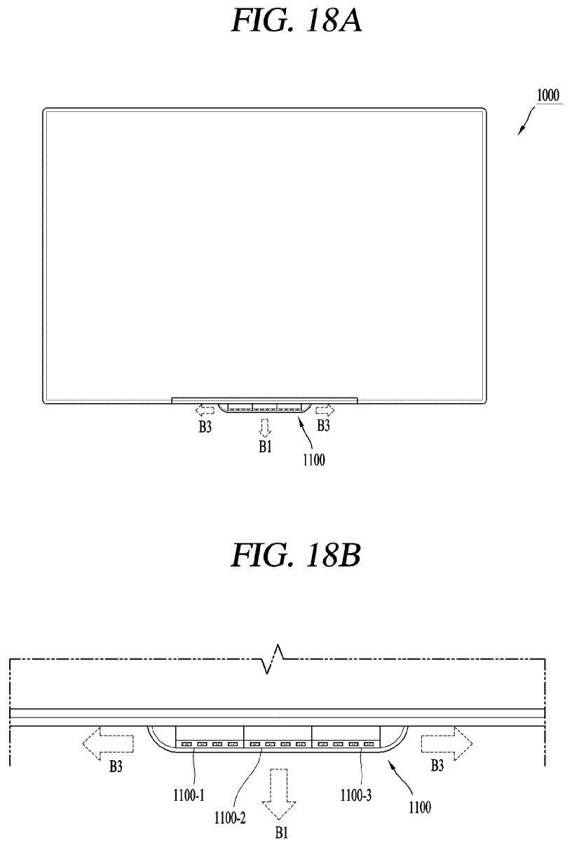

An antenna module implemented as a dual-polarized antenna disclosed herein may be configured as an array antenna in an electronic device. In this regard, FIG. 18A illustrates a structure in which an antenna module constituted by a plurality of array antennas is arranged in an electronic device. FIG. 18B is an enlarged view of a plurality of array antenna modules of FIG. 18A.

Referring to FIGS. 1 to 18B, an array antenna may include the first antenna module 1100-1 and the second antenna module 1100-2 arranged apart from the first antenna module 1100-1 by a predetermined space in a first horizontal direction. Meanwhile, antenna modules are not limited to two antenna modules. Three or more antenna modules may be implemented as illustrated in FIG. 20B. Accordingly, the antenna modules may be configured to include first to third antenna modules 1100-1 to 1100-3.

The processor 1400 of FIGS. 5 to 6C may control to generate a first beam and a second beam in a first direction and a second direction using the first and second antenna modules 1100-1 and 1100-2, respectively. That is, the first beam may be generated from a horizontal direction toward the first direction using the first antenna module 1100-1. In addition, the second beam may be generated from a horizontal direction toward the second direction using the second antenna module 1100-2. In relation to this, the processor 1400 may perform MIMO using the first beam in the first direction and the second beam in the second direction.

The processor 1400 may generate a third beam in a third direction using the first and second antenna modules 1100-1 and 1100-2. In relation to this, the processor 1400 may control the transceiver circuit 1250 to synthesize signals received through the first and second antenna modules 1100-1 and 1100-2. Also, the processor 1400 may control signals transmitted to the first and second antenna modules 1100-1 and 1100-2 through the transceiver circuit 1250 to be distributed to each antenna element. The processor 1400 may perform beamforming using the third beam having a beam width smaller than each of beam widths of the first beam and the second beam.

Meanwhile, the processor 1400 may perform MIMO using the first beam in the first direction and the second beam in the second direction, and perform beamforming using the third beam having a beam width smaller than each of beam widths of the first and second beams, In relation to this, when quality of a first signal and a second signal received from another electronic device in a periphery of the electronic device is equal to or less than a threshold, beamforming may be performed using the third beam.

A number of elements of the array antenna is not limited to two, three, four, or the like as illustrated in the drawing. For example, the number of the elements of the array antenna may extend to 2, 4, 8, 16, or the like. Accordingly, the array antenna may be configured as a 1×2, 1×3, 1×4, 1×5, . . . 1×8 array antenna.

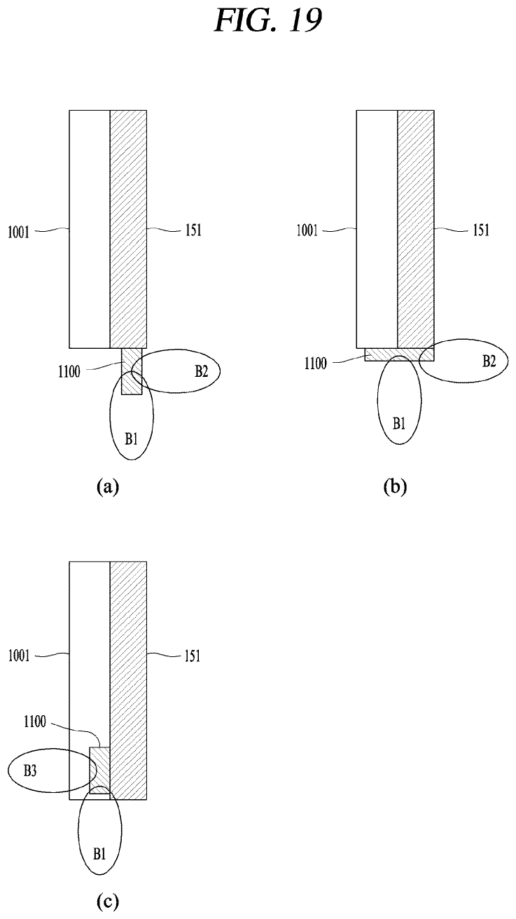

FIG. 19 illustrates antenna modules combined to have different combination structures at a particular position in the electronic device. Referring to (a) of FIG. 19, the antenna module 1100 may be arranged on a lower region of the display 151 to be substantially horizontal to the display 151. Accordingly, a beam B1 may be generated in a lower direction of the electronic device through one array antenna among a plurality of array antenna modules. Meanwhile, another beam B2 may be generated in a front direction of the electronic device through another array antenna among the plurality of array antenna modules.

Referring to (b) of FIG. 19, the array antenna module 1100 may be arranged on a lower region of the display 151 to be substantially vertical to the display 151 . . . . Accordingly, a beam B2 may be generated in a front direction of the electronic device through one array antenna among the plurality of array antenna modules. Meanwhile, another beam B1 may be generated in a lower direction of the electronic device through another array antenna among the plurality of array antenna modules.

Referring to (c) of FIG. 19, the antenna module 1100 may be arranged in a rear case 1001 corresponding to a mechanical structure. The antenna module 1100 may be arranged in the rear case 1001 to be substantially in parallel with the display 151. Accordingly, a beam B1 may be generated in a lower direction of the electronic device through one array antenna among a plurality of array antenna modules. Meanwhile, another beam B3 may be generated in a rear direction of the electronic device through another array antenna among the plurality of array antenna modules.

Hereinafter, technical effects of an antenna module implemented as a horizontally polarized antenna according to this specification and an electronic device including the antenna module are described.

According to an embodiment, an antenna module in which a horizontally polarized antenna operating in a millimeter wave band is implemented, and an electronic device including the antenna module may be provided.

According to an embodiment, isolation characteristics between horizontally polarized antenna elements having a loop shape in which a feed pattern and a ground conductive pattern are configured to have an inwardly concave structure may be improved.

According to an embodiment, isolation characteristics between horizontally polarized antenna elements having a loop shape in which a feed pattern and a ground conductive pattern are configured to have a structure convex toward an outer side may be improved.

According to an embodiment, horizontally polarized antenna elements having a loop shape may share a space with vertically polarized antennas while avoiding overlapping therebetween.

According to an embodiment, isolation characteristics between antenna elements may be improved through a sigma-loop shape having an orthogonal arrangement structure between corresponding sub patterns between adjacent antenna elements.

According to an embodiment, an end-fire antenna of a millimeter wave band, the end-fire antenna being configured to radiate from an end portion of one side of an antenna module implemented to have a multilayer substrate structure, may be implemented.

According to an embodiment, isolation characteristics between horizontally/vertically polarized antenna elements may be maintained in a structure in which the horizontally polarized antenna having a loop shape and the vertically polarized antenna having a different structure share a space in a PCB.

According to an embodiment, wireless communication may be performed with a peripheral electronic device by optimally arranging an antenna module on a lower portion of an electronic device.

Further scope of applicability of this specification will become apparent from the following detailed description. It should be understood, however, that the detailed description and specific examples, such as the preferred embodiment of the disclosure, are given by way of illustration only, since various changes and modifications within the spirit and scope of the disclosure will be apparent to those skilled in the art. In relation to this specification described above, designing and driving of an antenna operating in a mm Wave band and an electronic device controlling the antenna may be implemented as computer-readable codes on a medium having a program recorded thereon.

The computer-readable medium includes all kinds of recording devices in which data readable by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device and the like, and may also be implemented in the form of a carrier wave (e.g., transmission over the Internet). The computer may include the control unit of the terminal. Therefore, it should also be understood that the above-described embodiments are not limited by any of the details of the foregoing description, unless otherwise specified, but rather should be construed broadly within its scope as defined in the appended claims, The scope of this specification should be determined by reasonable interpretation of the appended claims, and all changes within the scope of equivalents of this specification are included in the scope of this specification.

1. An antenna module comprising a multilayer substrate made of a plurality of dielectric materials and a conductive pattern,
wherein the multilayer substrate comprises:
a first layer made of a flexible first material;
second layers comprising a plurality of layers made of a rigid second material arranged on one side surface of the first layer; and
third layers comprising a plurality of layers made of the rigid second material arranged on another side surface of the first layer,
the first layer comprises a first region arranged in parallel with the second layers and the third layers and a second region arranged to be vertical to the second layers and the third layers, and
the conductive pattern comprises:
a first conductive pattern arranged on a first sub-layer which is one layer among the second layers;
a second conductive pattern arranged to be spaced apart from the first conductive pattern on the first sub-layer; and
a third conductive pattern configured to be connected to the first conductive pattern and the second conductive pattern, and
the first conductive pattern comprises a first sub pattern and a second sub pattern,
the second conductive pattern comprises a third sub pattern and a fourth sub pattern,
the first sub pattern is connected to a feed line of the multilayer substrate,
the third sub pattern is connected to a ground line of the multilayer substrate, and
a distance between a first connection point between the first sub pattern and the second sub pattern and a second connection point between the third sub pattern and the fourth sub pattern is different from a length of the third conductive pattern.

2. The antenna module of claim 1, wherein the first sub pattern is arranged to be inclined toward an inner region with reference to the feed line.
the second sub pattern is arranged to be inclined toward an outer region with reference to the feed line,
the third sub pattern is arranged to be inclined toward an inner region with reference to the ground line, and
the fourth sub pattern is arranged to be inclined toward an outer region with respect to the ground line.

3. The antenna module of claim 2, wherein a length of the third conductive pattern is configured to be greater than a space in a gap between the first connection point and the second connection point.

4. The antenna module of claim 1, wherein the first sub pattern is arranged to be inclined toward an outer region with reference to the feed line,
the second sub pattern is arranged to be inclined toward an inner region with reference to the feed line,
the third sub pattern is arranged to be inclined toward an outer region with reference to the ground line, and
the fourth sub pattern is arranged to be inclined toward an inner region with respect to the ground line.

5. The antenna module of claim 4, wherein a length of the third conductive pattern is configured to be smaller than a space in a gap between the first connection point and the second connection point.

6. The antenna module of claim 1, wherein the conductive pattern further comprises a fourth conductive pattern arranged on the one side surface in the first region and the second region of the one side surface of the first layer to transmit and receive a signal, and
the fourth conductive pattern arranged in the first region is arranged in a middle region between the first conductive pattern and the second conductive pattern.

7. The antenna module of claim 1, wherein the multilayer substrate further comprises a ground wall in which conductive patterns are connected between the plurality of dielectric layers through ground vias,
the feed line connected to the first sub pattern is arranged within the ground wall, and
the feed line is arranged between ground patterns within the ground wall to constitute a coplanar waveguide (CPW) feed structure.

8. The antenna module of claim 1, wherein a distance d1, in a first axial direction, from one end portion of the first sub pattern to another end portion of the first sub pattern arranged at the first connection point is configured as 0.06 λ₀<d1< a half of a length of the conductive pattern, and
a distance d2, in the first axial direction, from one end portion of the third sub pattern to another end portion of the second sub pattern arranged at the second connection point is configured as 0.06 λ₀<d2< a half of a length of the conductive pattern.

9. The antenna module of claim 8, wherein a length of the first sub pattern is configured to be greater than a length of the third sub pattern, and
a first point on a second axis of the feed line connected to one end portion of the first sub pattern is a further inner point in the multilayer substrate compared to a second point on the second axis of the ground line connected to one end portion of the third sub pattern.

10. The antenna module of claim 8, wherein the first connection point between the first sub pattern and the second sub pattern and the second connection point between the third sub pattern and the fourth sub pattern are arranged at a same point in a second axial direction vertical to the first axial direction.

11. The antenna module of claim 1, wherein an electrical length of an antenna element comprising the first conductive pattern, the second conductive pattern, and the third conductive pattern is set to a predetermined range with reference to one time an operating wavelength (λg) corresponding to an operating frequency.

12. The antenna module of claim 11, wherein the antenna element operates as a horizontally polarized antenna,
a vertically polarized antenna comprising fourth conductive pattern vertically connected to a feed pattern arranged on a second sub-layer other than the first sub-layer to extend to an upper region is further comprised,
the vertically polarized antenna comprises a fifth conductive pattern arranged on a third sub-layer, which is one layer among the third layers, and a sixth conductive pattern arranged on a fourth sub-layer, which is another layer among the third layers,
the fifth conductive pattern and the sixth conductive pattern are connected to each other through a via structure, and
the via structure comprises via holes arranged in a plurality of rows and stacked vertically.

13. The antenna module of claim 12, wherein the antenna element is arranged in plurality in first axial direction to constitute an array antenna,
a first horizontally polarized antenna element to a fourth horizontally polarized antenna element of the array antenna are configured to radiate a beamformed first wireless signal in the first axial direction, and
a first vertically polarized antenna element to a fourth vertically polarized antenna element of the array antenna are configured to radiate a beamformed second wireless signal in the first axial direction.

14. The antenna module of claim 13, wherein sub patterns constituting ground connection patterns of the first horizontally polarized antenna are connected to each other at a second point in a second axial direction,
sub patterns constituting a feed pattern of the second horizontally polarized antenna adjacent to the first horizontally polarized antenna are connected to each other at a third point in the second axial direction,
the third point is configured as a point different from the second point in the second axial direction so that shapes of the first horizontally polarized antenna and the second horizontally polarized antenna are different from each other,
the third point is arranged in a further inner region in the multilayer substrate compared to the second point, and
a distance d3 from the second point to the third point is configured to be 0.04 λ₀ or greater.

15. The antenna module of claim 7, further comprising a shield can arranged on a ground pattern in an upper portion of the ground wall of the multilayer substrate
wherein a distance d from the shield can to a flexible substrate on which the third conductive pattern is arranged is configured to be in a range of (0.17+n)*λ₀<d<(0.33+n)*λ₀.

16. An electronic device having an antenna module, the electronic device comprising:
a metal frame constituting a side surface region of the electronic device;
a dielectric case arranged on one side of the metal frame; and
an antenna module arranged in an inner region of the dielectric case, arranged to face an inner surface of the dielectric case, and comprising a multilayer substrate made of a plurality of dielectric materials and a conductive pattern,
wherein the multilayer substrate comprises:
a first layer made of a flexible first material;
second layers comprising a plurality of layers made of a rigid second material arranged on one side surface of the first layer; and
third layers comprising a plurality of layers made of the rigid second material arranged on another side surface of the first layer,
the first layer comprises a first region arranged in parallel with the second layers and the third layers and a second region arranged to be vertical to the second layers and the third layers,
the conductive pattern comprises:
a first conductive pattern arranged on a first sub-layer which is one layer among the second layers;
a second conductive pattern arranged to be spaced apart from the first conductive pattern on the first sub-layer; and
a third conductive pattern configured to be connected to the first conductive pattern and the second conductive pattern, and
the first conductive pattern comprises a first sub pattern and a second sub pattern,
the second conductive pattern comprises a third sub pattern and a fourth sub pattern,
the first sub pattern is connected to a feed line of the multilayer substrate,
the third sub pattern is connected to a ground line of the multilayer substrate, and
a distance between a first connection point between the first sub pattern and the second sub pattern and a second connection point between the third sub pattern and the fourth sub pattern is different from a length of the third conductive pattern.

17. The electronic device of claim 16, wherein the first sub pattern is arranged to be inclined toward an inner region with reference to the feed line,
the second sub pattern is arranged to be inclined toward an outer region with reference to the feed line,
the third sub pattern is arranged to be inclined toward an inner region with reference to the ground line, and
the fourth sub pattern is arranged to be inclined toward an outer region with respect to the ground line.

18. The electronic device of claim 17, wherein a length of the third conductive pattern is configured to be greater than a space in a gap between the first connection point and the second connection point.

19. The electronic device of claim 16, wherein the first sub pattern is arranged to be inclined toward an outer region with reference to the feed line,
the second sub pattern is arranged to be inclined toward an inner region with reference to the feed line,
the third sub pattern is arranged to be inclined toward an outer region with reference to the ground line, and
the fourth sub pattern is arranged to be inclined toward an inner region with respect to the ground line.

20. The electronic device of claim 19, wherein a length of the third conductive pattern is configured to be smaller than a space in a gap between the first connection point and the second connection point.
